(19) United States
(12) Patent Application Publication
(10) Pub. No.: US 2025/0103619 A1
(43) Pub. Date: Mar. 27, 2025

(54) MODELING EXPERTISE BASED ON UNSTRUCTURED EVIDENCE

(71) Applicant: Microsoft Technology Licensing, LLC, Redmond, WA (US)

(72) Inventors: Gungor Polatkan, San Jose, CA (US); Jun Liu, Bellevue, WA (US); Diane Lee, Sunnyvale, CA (US); Rui Ma, New York, NY (US); Yanen Li, Savoy, IL (US); Di Zhou, Newark, CA (US); Zhuliu Li, San Jose, CA (US); Necip Fazil Ayan, Menlo Park, CA (US)

(21) Appl. No.: 18/476,166

(22) Filed: Sep. 27, 2023

(51) Int. Cl. G06F 16/332; G06F 16/335; G06F 16/383; G06N 7/01

(52) U.S. Cl. CPC G06F 16/332; G06F 16/383; G06N 3/042; G06N 3/045; G06N 5/022

(57) ABSTRACT

Embodiments of the disclosed technologies obtain evidence from at least one electronic data source. The evidence can include unstructured data associated with an entity. A set of entity features is extracted from the evidence. The set of entity features includes at least one digital description of expertise associated with the entity. The set of entity features, including the at least one digital description of expertise, is encoded, in digital form, into an entity feature embedding. At least one entity expertise embedding is extracted from the entity feature embedding. The at least one entity expertise embedding encodes an entity domain and a level of expertise of the entity in the entity domain. The at least one entity expertise embedding can be stored in digital form as an entity embedding and/or provided to at least one downstream process, model, component, network, and/or system.

### TECHNICAL FIELD

A technical field to which the present disclosure relates includes information retrieval systems. Another technical field to which the present disclosure relates includes the training of neural networks to generate embeddings.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

In machine learning, an embedding is a numerical representation of a real-world concept or object. For example, in natural language processing (NLP), a word embedding can represent a word as a vector of real numbers.

### BRIEF DESCRIPTION OF THE DRAWINGS

The disclosure will be understood more fully from the detailed description given below and from the accompanying drawings of various embodiments of the disclosure. The drawings are for explanation and understanding only and should not be taken to limit the disclosure to the specific embodiments shown.

FIG. 1 is a flow diagram of an example method for generating an entity embedding using components of an expertise modeling system in accordance with some embodiments of the present disclosure.

FIG. 2 is a flow diagram of an example method for generating predictive output based on expertise embeddings using components of an expertise modeling system in accordance with some embodiments of the present disclosure.

FIG. 3 is a flow diagram of an example method for training an expertise model using components of an expertise modeling system in accordance with some embodiments of the present disclosure.

FIG. 4 is a block diagram of a computing system that includes an expertise modeling system in accordance with some embodiments of the present disclosure.

FIG. 5 is a flow diagram of an example method for generating entity embeddings using components of an expertise modeling system in accordance with some embodiments of the present disclosure.

FIG. 6 is a block diagram of an example computer system including components of an expertise modeling system in accordance with some embodiments of the present disclosure.

### DETAILED DESCRIPTION

Computer users around the world have come to rely on online systems as a primary source of information about virtually any topic. From news feeds to search results to online dialogs, many users have come to trust that the information online systems provide to them is accurate and reliable. As the amount of information circulating on a global network such as the Internet continues to proliferate, it is a continuing technical challenge for information retrieval systems to find and return reliable information that is most relevant to user requests.

In this regard, a specific challenge of information retrieval systems is interpreting and validating descriptions of domain expertise both in queries and in sets of potentially matching search results. Domain as used herein may refer to a skill, field, or area of knowledge, activity, experience, influence, or interest, at any level of granularity. For instance, a domain could be corporate law, software engineering, graphic design, microbiology, French cuisine, middle school language arts education, birdwatching, residential housing construction, project management, or leadership.

Expertise as used herein may refer to an association between a domain and an entity in a general sense without regard to any particular level of expertise; for example, expertise may be used to indicate that an entity has some level of knowledge, activity, experience, influence, interest, or skills within a particular domain, irrespective of whether the entity's specific level of expertise in the domain has been determined or verified. For example, the publication by a user of an article about a particular topic can be evidence of the user's expertise in that topic, while the actual content of the article, the educational background of the user, and/or other data, can provide evidence of the user's actual level of expertise in the topic. Similarly, the fact that a user lists certain skills on their online profile page can be evidence of the user's expertise in those skills, and statements made by the user summarizing their skill set (e.g., “I have ten years of experience in natural language processing”) could be evidence of the user's actual level of expertise.

Expertise can be explicitly stated, implied or inferred. For example, a user's profile page in an online system may explicitly list specific skills or the user's summary of experience may contain an explicit statement that the user is “a thought leader” in a particular domain. On the other hand, expertise may be implied or inferred based on a user's online activity, such as articles published or comments posted by the user, or based on other users' responses to the user's online activity, such as social reactions, comments, shares, and follows.

It is a challenge for information retrieval systems to interpret descriptions of expertise that are provided online. In addition to challenges relating to lack of clarity or ambiguity, descriptions of expertise can vary widely in terms of reliability. For example, third-party statements about a user's level of expertise may be more reliable than the user's self-reported expertise. As another example, the reliability of a user's assertions about their own expertise may vary depending on the context. For instance, descriptions of expertise provided on a job application or resume may be more reliable than those posted to an online profile or in an online comment.

Another challenge of information retrieval systems is how the information retrieval systems identifies particular levels of expertise to ensure that the information retrieved in response to a query matches the actual level of expertise desired by the query. For instance, some conventional information retrieval systems might, in response to a query containing the search term “senior software engineer,” return all user profiles that contain the search term “software engineer,” regardless of level of expertise, because the conventional systems are unable to determine levels of expertise from the information provided in the user profiles and/or are unable to determine which levels of expertise correspond to the search term, “senior.”

As another example, some conventional information retrieval systems are limited by the use of a skill taxonomy that forces descriptions of expertise to be mapped to the skill taxonomy. These conventional systems might be able to compute scores for user-skill pairs but only if the skills are represented in the system's taxonomy. Thus, types of expertise that are not represented by skills in the system's taxonomy cannot be scored. Also, the scoring of user-skill pairs may be task-specific in that the score for a certain user-skill pair may be relevant for one type of query but not relevant for another query type. Therefore, conventional methods of scoring user-skill pairs are not optimized for information retrieval across a broad set of potential areas and levels of expertise, queries and/or use cases.

A skill taxonomy used by conventional information retrieval systems may be able to represent levels of expertise as a static, hierarchical set of discrete categories such as no expertise, beginner, intermediate, and advanced. However, levels of expertise often can be described in many different ways and may be described differently in different contexts, such that it is impossible for the information retrieval system to anticipate all the different, non-discrete, ways in which levels of expertise may be described across many different domains, queries, and use cases.

For example, different queries in different contexts might aim to identify a set of the “best” candidates for a particular job or a set of people who are “eligible” for a particular opportunity or a set of people who are “good at” a particular skill. As another example, expertise levels might be described differently in different domains. For instance, in cooking, expertise levels might be described as “amateur,” “avid cook,” and “professional chef,” while in law, skill levels might be described as “associate” and “partner” or “first-chair.” As such, user-skill pairs and search results cannot be scored, filtered or expanded based on levels of expertise if those levels of expertise are not represented in the system's taxonomy.

For these and other reasons, previous attempts at incorporating levels of expertise into information retrieval have not achieved satisfactory results. The shortcomings of the prior methods can negatively impact users' ability to trust and rely on results provided by the information retrieval system. This leads to undesirable downstream consequences such as repetitive query iterations, unnecessary database accesses, and increases in network communications, leading to inefficient uses of computing resources and users potentially abandoning the information retrieval system.

To address these and other technical challenges of conventional information retrieval systems, the disclosed technologies can generate evidence-based entity expertise embeddings that encode levels of expertise into the embeddings in an automated way. Entity as used herein may refer to, for example, a user of an online system, a company, institution, or organization, or a digital content item such as an article, video, image, audio recording, or job posting, or a query, such as a search request for job candidates having a certain level of expertise in a particular field, a request to identify a user's top skills, or a request to identify the top job opportunities based on a user's levels of expertise. As described in more detail below, aspects of the disclosed technologies can obtain evidence of entity expertise from a wide variety of sources, extract features from the evidence, and generate, from the extracted features, entity expertise embeddings that encode level of expertise information associated with the entity.

Because the expertise embeddings are generated based on evidence, the types and/or levels of expertise that can be represented by the expertise embeddings are unlimited, e.g., not constrained by any taxonomy. Additionally or alternatively, the use of evidence to generate the expertise embeddings can improve the reliability and/or accuracy of the levels of expertise represented by the expertise embeddings because information about the reliability of the sources of the evidence used to generate the expertise embeddings can be automatically encoded into the expertise embeddings.

The expertise embeddings can be output to, for example, one or more downstream models, processes, components, networks, or systems. Alternatively or in addition, aspects of the disclosed technologies can generate predictive output based on computations performed on sets or pairs of expertise embeddings. For example, aspects of the disclosed technologies can generate comparisons of entities and queries based on the expertise embeddings associated with the entities and queries. As another example, aspects of the disclosed technologies can generate rankings of entities based on the expertise embeddings associated with the entities. As a further example, embodiments can generate query suggestions based on the expertise embeddings. For example, the expertise embeddings can be used to suggest queries, or to enhance or modify queries, e.g., by suggesting additional or different query terms to include such as particular descriptions of expertise that may be applicable in a particular domain.

In some implementations, the entity for which expertise embeddings are generated by the disclosed technologies is a computing resource rather than a human, document, or company. For example, entity features associated with a set of candidate computing resources can be input to an embodiment of the disclosed technologies to produce an expertise embedding that represents the suitability of each of the candidate computing resources for a particular computing task. The expertise embeddings can then be used to allocate computing resources to computing tasks accordingly. Examples of computing resources could include different types and/or version of machine learning models. Expertise embeddings can be computed for each of the different machine learning models and then the expertise embeddings can be used to select a model for a particular computing task.

Certain aspects of the disclosed technologies are described in the context of searches for entities having desired levels of expertise, such as searches for prospective job candidates, job searches, searches for prospective contributors to articles and/or other forms of content, and rankings of entities based on level of expertise. However, aspects of the disclosed technologies are not limited to such contexts, but can be used to improve information retrieval in other contexts in which the information retrieval system needs to interpret expertise levels or another type of attribute that has an indeterminate or variable number of non-discrete levels.

Any network-based application software system can act as an application software system to which the disclosed technologies can be applied. For example, news, entertainment, and e-commerce apps installed on mobile devices, enterprise systems, messaging systems, search engines, workflow management systems, collaboration tools, and social graph-based applications can all function as application software systems with which the disclosed technologies can be used.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

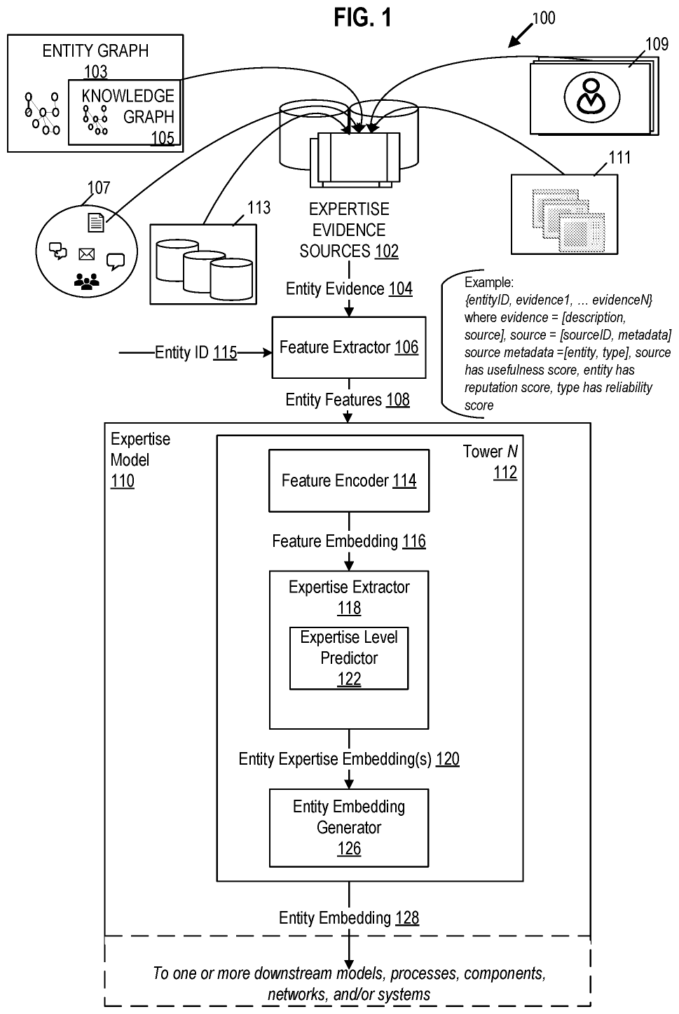

FIG. 1 is a flow diagram of an example method for generating an entity embedding using components of an expertise modeling system in accordance with some embodiments of the present disclosure. In FIG. 1, a computing system 100 generates entity expertise embeddings based on evidence obtained from one or more sources of expertise evidence.

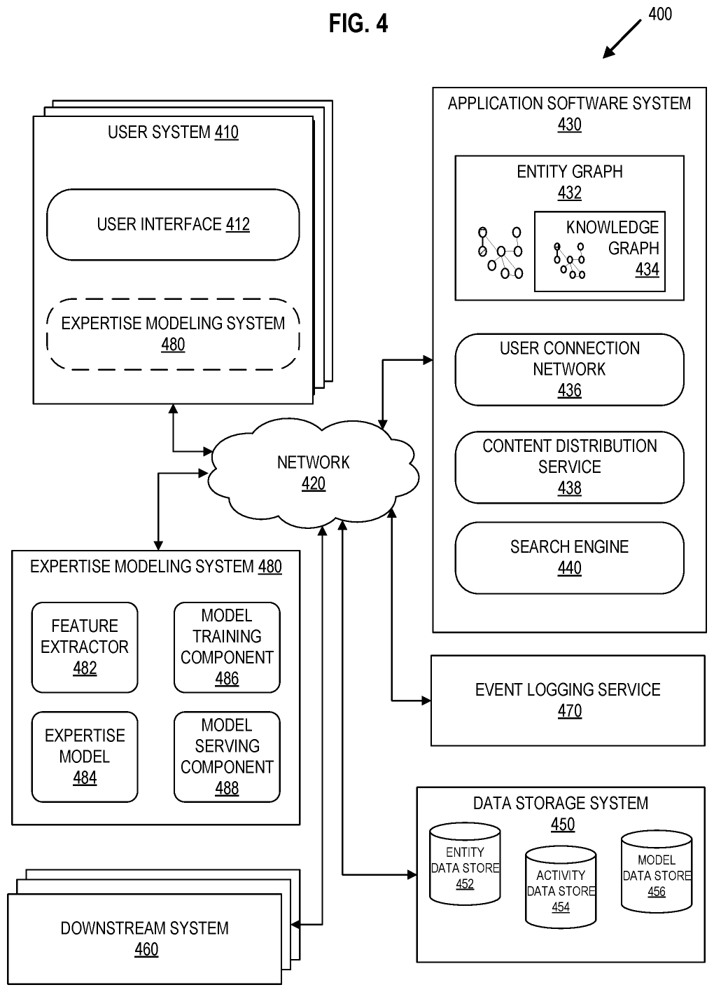

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an expertise modeling system, including, in some embodiments, components shown in FIG. 1 that may not be specifically shown in one or more of the other figures, or by components of expertise modeling system 480 of FIG. 4, including, in some embodiments, components shown in FIG. 4 that may not be specifically shown in FIG. 1, or by components of any of computing systems 200, 300, 500, or 600, which may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, the computing system 100 includes an example expertise modeling system. The expertise modeling system of computing system 100 includes expertise evidence sources 102, a feature extractor 106, and an expertise model 110, as described in more detail below.

In the example of FIG. 1, the components of the expertise modeling system are implemented using an application server or server cluster, which can include a secure environment (e.g., secure enclave, encryption system, etc.) for the processing of expertise data. In other implementations, one or more components of the expertise modeling system are implemented on a client device, such as a user system 410, described herein with reference to FIG. 4. For example, some or all of expertise modeling system is implemented directly on the user's client device, in some implementations, thereby avoiding the need to communicate with servers over a network such as the Internet.

In the example of FIG. 1, the expertise modeling system is used to generate entity embeddings that encode expertise information. For example, given an entity identifier 115, feature extractor 106 generates entity features 108 for the entity based on one or more items of entity evidence 104 that are associated with the entity. Feature extractor 106 formulates the entity features 108 to be used as inputs to expertise model 110 at inference time. For example, feature extractor 106 creates an instance of entity features 108 for the entity identified by the entity ID 115 based on one or more items of entity evidence 104, where the instance of entity features 108 has a structured data format. An example of an item of entity features 108 can be represented as: {entityID, evidence1, . . . , evidenceN}, where the entityID identifies the entity (e.g., a user account identifier, device identifier, network address, session identifier, or group identifier), an item of evidence contains a source identifier and a description of the evidence obtained from the source, where the source identifier identifies the source of the item of evidence (e.g., an application identifier, server identifier, or database identifier), and N is a positive integer.

As shown in the example of FIG. 1, an item of evidence has a source. In some implementations, metadata about the source of evidence is included in the entity features along with the source identifier. Alternatively, the metadata about the source (source metadata) can be maintained in a data store and obtained by, e.g., querying the data store using the source identifier. Examples of source metadata include the source entity (e.g., the entity providing the evidence, such as a first-party entity or a third-party entity) and the source type (e.g., the method or channel by which the evidence is provided, such as a social media post, an article, an academic paper, a comment on a post, a picture of an awards ceremony or certificate, etc.).

The usefulness of an item of evidence can be dependent upon the source of the evidence and the particular entity ID 115. For example, different sources of evidence can be selected and ranked by feature extractor 106 based on the usefulness of the sources to a particular entity ID 115. A source's usefulness score or rating can be determined by feature extractor 106 by analyzing the source's metadata. For instance, a source's usefulness score can be computed by the feature extractor 106 based on a reputation score assigned to the source entity and/or a reliability score assigned to the source type. As an example, if the source entity ID is the same as the entity ID 115 (e.g., a user is providing evidence of their own expertise), the feature extractor 106 may set the reputation score for the source entity lower than if the source entity ID is different from the entity ID 115. If the source type is profile page, the feature extractor 106 may set the reliability score for the source type lower than if the source type is a job application. Reputation scores for source entities may be computed by the feature extractor 106 based on the receipt of an entity ID 115. Reliability scores for source types may be pre-computed, stored, and retrieved by the feature extractor 106 at the receipt of an entity ID 115.

Feature extractor 106 can compute a source's usefulness score for a particular entity ID 115 as a combination (e.g., a sum or weighted sum) of the reputation score for the source entity and the reliability score for the source type. Feature extractor 106 can filter or select entity evidence 104 relevant to a particular entity ID 115 based on one or more of the source usefulness scores.

An item of entity evidence 104 used to formulate entity features 108 can contain unstructured data such as natural language text, digital imagery, video, audio, or a combination of any of the foregoing. The entity evidence 104 can contain an implicit or explicit description, statement, or assertion about an entity's level of expertise in a particular domain. Levels of expertise can be expressed in many different ways in different forms of evidence, including as discrete or continuous bands of expert levels or ordinal values. Examples of explicit items of entity evidence 104 include skill descriptions contained in a user's profile and experience, achievements, or interests described on the user's resume or job application. Examples of implicit items of entity evidence 104 include articles, posts, and comments that the user has created and distributed online, social reactions to content that the user has posted online (e.g., likes, comments, shares, follows), and articles or papers that have been viewed, reacted to, or commented upon by the user online.

The entity evidence 104 can include first-party evidence or third-party evidence. For example, first-party evidence includes instances in which the user themselves has self-reported their skills, knowledge, or level of expertise, such as by broadcasting a post about a recent award or achievement, or by identifying themselves as a “expert” in their online profile, post, or comment. Third-party evidence includes instances in which a third person has reported, commented, or opined on the first-party user's capabilities. For example, third-party evidence includes online recommendations and endorsements of the user submitted by other users, and social reactions of third-party users to the first-party user's posts and comments.

An item of entity evidence 104 can include activity data alone or in combination with one or more other forms of evidence. For example, a first item of evidence, evidence 1, could be a section of a user profile that explicitly describes the user's skills, whereas a second item of evidence, evidence 2, could include activity data that indicates that the user submitted an online application in response to a particular job posting, along with text of the job posting to which the user applied. As another example, an item of evidence could include an article posted by the user via an online system along with online activity statistics computed on the social reactions to the article in the online system (e.g., reaction count or distribution across different types of reactions).

Feature extractor 106 obtains the various one or more items of entity evidence 104 from one or more expertise evidence sources 102. Examples of expertise evidence sources 102 shown in FIG. 1 include entity graph 103, knowledge graph 105, entity activity data 107, entity profile data 109, applications 111, and models 113. As discussed above, the expertise evidence sources 102 can be ranked and filtered or selected by feature extractor 106 based on one or more criteria such as usefulness scores. For example, suppose that the evidence for a particular user's expertise includes the user's profile and a recent post by the user. These different sources of evidence for the user can be ranked by feature extractor 106 based on a source usefulness score, which can include reliability of the source type and/or reputation of the source entity.

Alternatively or in addition, feature extractor 106 can apply one or more heuristics to the evidence and associated source metadata to resolve conflicts or inconsistencies between different pieces of evidence. For instance, suppose the user's profile indicates that the user is currently a junior associate at a law firm but the user's most recent social media post contains an announcement of the user's promotion to partner. In such an instance, the feature extractor 106 can detect the conflict by extracting the expertise information from the pieces of evidence (e.g., junior associate and partner), map each piece of evidence to an expertise level according to e.g., a taxonomy for law careers, and determine based on the taxonomy that the expertise levels are inconsistent or conflicting. The feature extractor 106 can resolve the conflict by applying a rule to the source metadata for each of the pieces of information. For example, a rule could cause the feature extractor 106 to assign a higher usefulness score to the social media post and a lower usefulness score to the user's profile because the social media post was created recently and the user's profile has not been updated since the social media post was created. As another example, a rule could cause the feature extractor 106 to adjust the number and/or type of sources used to generate the entity features 108. For example, if the entity ID 115 corresponds to a job description rather than a user, a rule could cause the feature extractor 106 to obtain evidence from a greater or fewer number of sources depending on the job type (e.g., obtain more evidence for bet-the-company litigators). As another example, a rule could cause the feature extractor 106 to adjust the number and/or types of sources used to generate the entity features 108 based on computing system performance levels or metrics (e.g., available network bandwidth, computational capacity, latency, etc.)

Entity graph 103 includes a graph-based representation of entity data. Entity graph 103 represents entities, such as users, organizations (e.g., companies, schools, institutions), and content items (e.g., user profiles, job postings, announcements, articles, comments, and shares), as nodes of a graph. Entity graph 103 represents relationships, also referred to as mappings or links, between or among entities as edges, or combinations of edges, between the nodes of the graph. In some implementations, mappings between or among different pieces of data are represented by one or more entity graphs (e.g., relationships between job postings, skills, and job titles). In some implementations, the edges, mappings, or links of the entity graph 103 indicate online interactions or activities relating to the entities connected by the edges, mappings, or links. For example, if a user applies for a job, an edge may be created connecting the user entity with the job entity in the entity graph, where the edge may be tagged with a label such as “applied.”

Portions of entity graph 103 can be automatically re-generated or updated from time to time based on changes and updates to the stored data, e.g., in response to updates to entity data and/or activity data. Also, entity graph 103 can refer to an entire system-wide entity graph or to only a portion of a system-wide graph, such as a sub-graph. For instance, entity graph 103 can refer to a sub-graph of a system-wide graph, where the sub-graph pertains to a particular entity or entity type.

In some implementations, knowledge graph 105 is a subset of entity graph 103 or a superset of entity graph 103 that also contains nodes and edges arranged in a similar manner as entity graph 103, and provides similar functionality as entity graph 103. For example, in some implementations, knowledge graph 105 includes multiple different entity graphs 103 that are joined by cross-application or cross-domain edges or links. For instance, knowledge graph 105 can join entity graphs 103 that have been created across multiple different databases or across multiple different software products. As an example, knowledge graph 105 can include links between job postings that are stored and managed by a first application software system and related company reviews or web pages that are stored and managed by a second application software system different from the first application software system. Entity graph 103 and/or knowledge graph 105 are capable of supplying sub-graphs of the entity graph and/or knowledge graph, entity data and/or link data to feature extractor 106 as items of entity evidence 104.

Various sources of activity data 107 can supply activity data to feature extractor 106 for use as entity evidence 104. Examples of activity data 107 include online interaction history, including social reactions, posts, articles and comments, messages, and interactions with web content (e.g., feed scrolling, views, impressions, and searches for or loads of web pages, such as user profile pages, company pages, articles, and posts).

Entity profile data 109 can include, for example, user profiles, company, institution, or organization profiles, skill pages, job profiles, or job posting pages. Entity evidence 104 obtained from entity profile data 109 can include entire profile pages or one or more sections or sub-sections of a profile page. Examples of sections of a profile page include a summary section, a work experience section, a skill description, an educational experience section, an interests section, or an endorsement section.

Applications 111 can include, for example, one or more domain-specific or domain-independent applications such as software platforms that are external to the application software system 430 but are accessible to the application software system via, e.g., one or more public APIs (application programming interfaces). Examples of applications 111 include data repositories such as online encyclopedias, dictionaries, and sources of multimedia content, content distribution services, web applications, and mobile device applications. Examples of entity evidence 104 obtained from applications 111 can include documents, notifications, videos, podcasts, images, event announcements, event agendas, ratings data, or transcripts of videos, podcasts, or events.

Models 113 can include, for example, artificial intelligence-based models such as discriminative and/or generative machine learning models or neural networks, heuristics-based models, rules engines, or optimization solvers. Examples of models 113 include binary classifiers, scoring models, ranking models, and recommendation systems. Examples of entity evidence 104 that can be obtained from models 113 include entity classifications, user connection recommendations, job recommendations (e.g., people you may know, jobs you may be interested in), content item rankings (e.g., feed rankings, notification rankings), and machine-generated digital content such as digital content generated and output by a generative model such as a large language model. For instance, a model 113 can take as input a skill extracted from a user's profile page and generate and output a natural language text skill description related to the input skill.

Given an entity identifier (ID) 115, feature extractor 106 queries one or more of the expertise evidence sources 102 for entity evidence 104 that matches the specified entity ID. Match or matching as used herein may refer to an exact match or an approximate match, e.g., a match based on a computation of similarity between two pieces of data or a partial string matching. An example of a similarity computation is cosine similarity. Other approaches that can be used to determine similarity between or among pieces of data include clustering algorithms (e.g., k means clustering), binary classifiers trained to determine whether two items in a pair are similar or not similar, neural network-based vectorization techniques such as WORD2VEC, and string matching. In some implementations, generative language models, such as large language models, are used to determine similarity of pieces of data.

In some embodiments, feature extractor 106 or another component of computing system 100 pre-processes the entity evidence 104 to map individual items of entity evidence 104 from the expertise evidence sources 102 to associated entity identifiers, and then feature extractor 106 sorts, filters, or groups the entity evidence 104 according to entity ID.

In some implementations, feature extractor 106 or another component of computing system 100 obtains or computes one or more source confidence scores for the expertise evidence sources 102 (such as the usefulness scores, reliability scores, and/or reputation scores described above). As discussed above, in some implementations, the feature extractor 106 ranks and selects or filters the expertise evidence sources 102 based on one or more of these source confidence scores. Alternatively or in addition, the expertise model 110 is trained using training data that includes, in each instance of training data, one or more ground truth confidence scores for the sources of evidence such as the usefulness score, source type reliability score, and/or source entity reputation score, and this training enables the feature extractor 106 to, at inference time, include the one or more source confidence scores in the entity features 108 which are used to generate the entity embedding 128 for a particular entity ID 115 during the inference phase.

As used herein, a confidence score may refer a measurement, such as a probabilistic or statistical likelihood, a discrete ranking value, score, or a real number, that evidence provided by the respective expertise evidence source 102 can be relied upon for the purpose of generating entity expertise embeddings using the expertise model 110. For example, a higher source confidence score can indicate that an expertise evidence source 102 is more reliable than an expertise evidence source with a lower source confidence score.

In some embodiments, the one or more source confidence scores are determined based on the source type. For example, first-party sources of evidence (e.g., where the user has self-reported capabilities on their own profile page) may have lower source confidence scores than third-party sources. In some embodiments, the source confidence scores are determined and/or updated based on feedback that computing system 100 receives from one or more downstream models, processes, components, networks, or systems that use the entity embedding 128 and/or associated predictive output.

A simplified example of entity features 108 that may be extracted by feature extractor 106 from entity evidence 104 is shown, in table form, in Table 1 below.

TABLE 1
Example of entity features.

| Feature ID | Entity ID | Evidence1 | Evidence2 | EvidenceN |
|---|---|---|---|---|
| F1 | E1 (a person) | [Published online | [published online | [5000 likes of |
| | | article A1 about | profile says, “check | article A1, S3] |
| | | generative language | out my new class | |
| | | models, S1] | on machine | |
| | | | learning!” and | |
| | | | includes a link to a | |
| | | | video, S2] | |
| F2 | E2 (a person) | [published online | [web link to law | [published law firm |
| | | post says | firm page | rankings data, S6] |
| | | “congratulations on | containing picture | |
| | | your promotion to | and bio indicating | |
| | | partner - so well | experience in | |
| | | deserved!”, S4] | corporate law, S5] | |
| F3 | E3 (a job) | [a job description | [web link to the | [a number of users |
| | | that says “Company | profile page of the | who have |
| | | A is a company that | company posting | saved/applied for |
| | | produces amazing | the job E3, | the job E3] |
| | | products. We are | including a text | |
| | | hiring a senior | description of the | |
| | | machine learning | company, its | |
| | | engineer for | industry, size, etc.] | |
| | | position N. The | | |
| | | requirements are A, | | |
| | | B, C. You | | |
| | | responsibilities are | | |
| | | X, Y, Z.] | | |

In the example of Table 1, each feature identifier (feature ID) identifies a set of N items of evidence associated with a particular entity identifier (entity ID), where N is a positive integer and the value of N can be different for different entities. In other examples, each item of evidence for each entity is identified by a different feature ID (e.g., [featureID, entityID, evidenceID]).

Each item of evidence includes the evidence and a source identifier. As shown in Table 1, the evidence can include unstructured data such as a published article, or text extracted from a user profile or post, an image, or a link to a web page containing a combination of image and text. Alternatively or in addition, the evidence can include activity data, such as a count of likes of an article, or data obtained from an external application, such as rankings data or online reviews. Still additionally or alternatively, the evidence can include output of a generative model, such as a summary of an online entity profile, a summary of an online article, or a summary of an online post and associated online comments.

In the example of Table 1, the source of each item of evidence is identified by a source identifier (e.g., S1, S2, . . . . SN). In some implementations, the source identifier identifies a source type of the respective expertise evidence source 102 (e.g., third-party source or first-party source), such that the feature extractor 106 can rank or filter the items of evidence based on the source type. In other implementations, the source identifier uniquely identifies the actual evidence source, such that the feature extractor 106 can use the source identifier to obtain the source confidence scores for the identified sources and filter or rank the items of evidence based on the source confidence scores.

In operation, feature extractor 106 provides the evidence-based entity features 108 extracted from the one or more expertise evidence sources 102, for input to expertise model 110. For example, feature extractor 106 formulates the entity features 108 as a set of token sequences. In response to entity features 108, expertise model 110 generates and outputs at least an entity embedding 128 based on the evidence-based entity features 108. The entity embedding 128 encodes level of expertise information via entity expertise embeddings 120, which are generated by expertise model 110 using the evidence-based entity features 108.

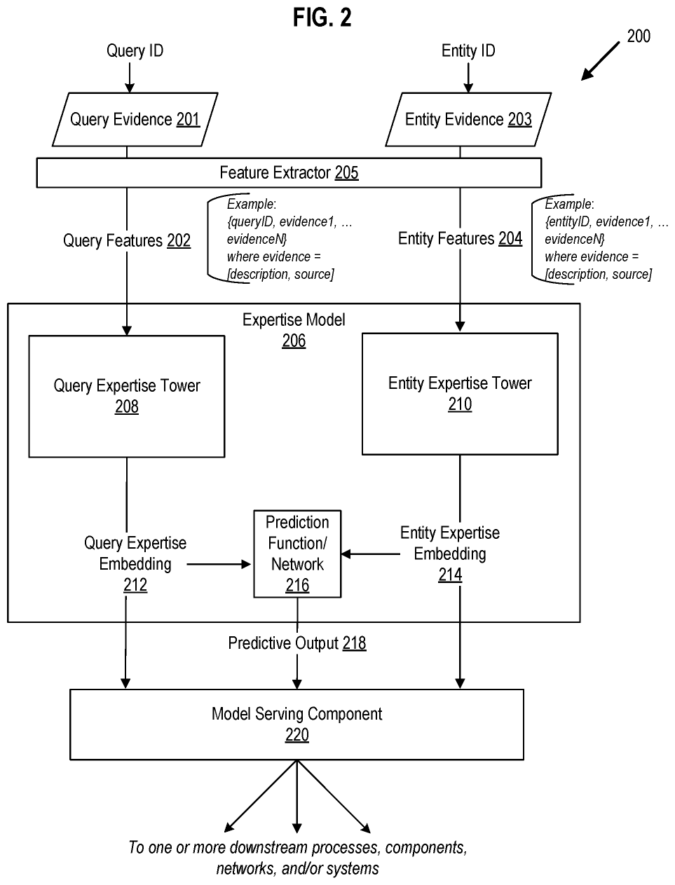

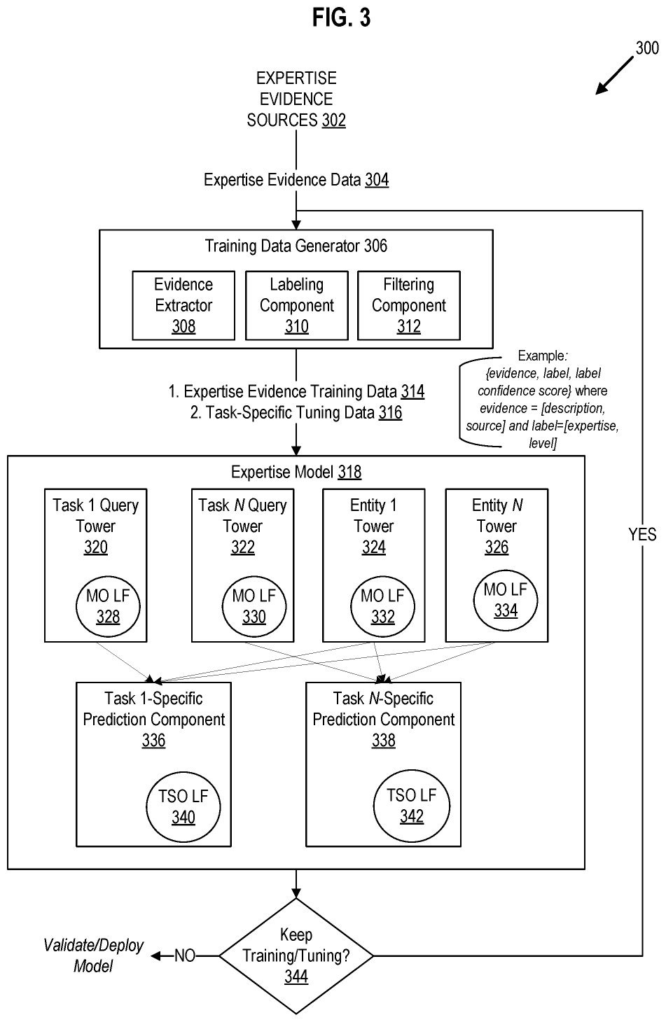

In some embodiments, such as expertise model 206 shown in FIG. 2, described below, expertise model 110 generates and outputs predictive output alternatively or in addition to one or more entity embeddings. As indicated by the designation of tower N 112 in FIG. 1, where Nis a positive integer, and as shown in FIG. 2 and FIG. 3, described below, embodiments of expertise model 110 can include multiple towers, each of which generates and outputs a different evidence-based entity embedding.

In some embodiments, such as expertise model 318 shown in FIG. 3, described below, expertise model 110 can include one or more task-specific sub-networks. For example, expertise model 110 is structured as a multi-objective neural network model trained via multi-task learning, in some implementations. An example of a multi-objective training process that can be used to train expertise model 110 is described below with reference to FIG. 3.

In the embodiment of expertise model 110 shown in FIG. 1, tower N 112 is a neural network tower that includes a feature encoder 114, an expertise extractor 118, an expertise level predictor 122, and an entity embedding generator 126. In embodiments where expertise model 110 contains multiple neural network towers 112 (i.e., where N is greater than 1), each of the N towers 112 has a similar architecture as is shown for tower N 112. That is, each of the N towers 112 of expertise model 110 includes a feature encoder 114, an expertise extractor 118, an expertise level predictor 122, and an entity embedding generator 126, in some implementations. In some embodiments, each of the N towers 112 is implemented using a deep neural network architecture in which feature encoder 114, expertise extractor 118, expertise level predictor 122, and entity embedding generator 126, are each implemented as neural networks of the deep neural network architecture. The exact number and arrangement of networks and components of each type as well as the hyperparameter values used to configure the tower are determined based on the requirements of a particular design or implementation of the expertise model 110.

In tower N 112, feature encoder 114 encodes entity features 108 and outputs the encoded entity features 108 as feature embedding 116. Feature embedding 116 is, for example, a dense representation of the entity features 108, which is created by the feature encoder 114 based on the entity features 108.

In some embodiments, feature encoder 114 includes one or more neural network-based machine learning models. In some implementations, feature encoder 114 is constructed using a neural network-based deep learning model architecture. In some examples, the neural network-based machine learning model architecture of feature encoder 114 includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models. In some examples, one or more types of neural network-based machine learning model architectures include or are based on one or more multimodal neural networks capable of outputting different modalities (e.g., text, image, sound, etc.) separately and/or in combination based on textual input. Accordingly, in some examples, feature encoder 114 includes a multimodal neural network capable of outputting expertise embeddings based on a combination of two or more of text, images, video or audio.

In some implementations, feature encoder 114 is trained on a large dataset of features extracted from digital content such as natural language text, images, videos, audio files, or multi-modal data sets. For example, training samples of features extracted from digital content such as natural language text obtained from publicly available data sources are used to train feature encoder 114. The size and composition of the datasets used to train feature encoder can vary according to the requirements of a particular design or implementation of the expertise modeling system. In some implementations, one or more of the datasets used to train feature encoder 114 includes hundreds of thousands to millions or more different training samples.

In some implementations, feature encoder 114 is implemented using a graph neural network. For example, a modified version of a Bidirectional Encoder Representation with Transformers (BERT) neural network is specifically configured to generate feature embedding 116.

Feature encoder 114 outputs feature embedding 116. Expertise extractor 118 is coupled to output of feature encoder 114. Expertise extractor 118 extracts expertise embeddings from feature embedding 116. Expertise level predictor 122 computes losses for the extracted expertise embeddings. Based on the losses, expertise extractor 118 generates and outputs one or more entity expertise embeddings 120 based on feature embedding 116. For example, expertise extractor 118 identifies one or more portions of feature embedding 116 that relate to expertise and generates and outputs a separate, explicit expertise embedding for each of the identified one or more areas of expertise. Using the first example in Table 1, for feature set F1, feature encoder 114 would convert the feature set F1 into a structured representation that encodes characteristics of the raw features such as the semantic meaning of text contained in the raw features, e.g., the feature embedding 116. Expertise extractor 118 applies an attention mechanism to the feature embedding 116 to extract portions of the feature embedding that relate to expertise. The attention mechanism adjusts the weight values associated with different portions of the input so that portions of the feature embedding that relate to expertise are weighted more highly than portions of the feature embedding that are not related to expertise. As an example, for feature F1 of Table 1, expertise extractor 118 could generate separate expertise embeddings for “generative language models” and “machine learning models” based on weighting adjustments applied by the attention

As such, in some implementations, the expertise extractor 118 includes one or more attention layers of the neural network-based machine learning model architecture of tower N 112. The one or more attention layers allow the expertise extractor 118 to assign different weights to different portions of the feature embedding 116, and generates the entity expertise embeddings 120 based on the weights. In some implementations, expertise extractor 118 and expertise level predictor 122 cooperate in an iterative expertise understanding process that encodes level of expertise information into the entity expertise embeddings 120. For example, expertise level predictor 122 predicts expertise levels based on the expertise embeddings extracted by the expertise extractor 118 and based on its training.

Using the example of feature set F1 of Table 1, expertise level predictor 122 could encode the “generative language model” expertise embedding with an expertise level of “proficient” based on one or more source confidence scores (e.g., usefulness, reliability, and/or reputation) associated with the publication of the article on generative language models and the activity data indicating a number of likes of the article. Expertise level predictor 122 could encode the “machine learning model” expertise embedding with an expertise level of “knowledgeable” e.g., a lower level of expertise, based on one or more source confidence scores associated with the user's self-promoting post on their own profile. Expertise level predictor 122 can predict levels of expertise based on, for example, statistical correlations between or among sources of evidence, levels of expertise and reliability, usefulness, or reputational information, where the statistical correlations are created and developed through the training process. An example of a training process is described below with reference to FIG. 3.

As discussed above, expertise levels can be expressed in many different ways and may be described differently in different domains. For instance, in cooking, expertise levels might be described as “amateur,” “avid cook,” and “professional chef,” while in law, skill levels might be described as “associate” and “partner” or “first-chair.” As well, expertise levels can be expressed in many different forms or formats, including sets of text categories, numerical rankings, percentages, real numbers, numerical ranges, ordinal values, hierarchies, bands of discrete values, bands of continuous values, etc. This disclosure is not limited to any particular form, format, or expression of levels of expertise that may be contained in the evidence data used to train the expertise model or during use of the trained expertise model at inference time.

Expertise extractor 118 outputs one or more entity expertise embeddings 120. Entity embedding generator 126 is coupled to output of entity extractor 118. Entity embedding generator 126 creates entity embedding 128 by combining the one or more entity expertise embeddings 120 produced by expertise extractor 118 into entity embedding 128. As a result, the entity embedding 128 produced by entity embedding generator 126 of tower N 112 encodes level of expertise information about the entity associated with entity ID 115, which has been obtained from one or more expertise evidence sources 102, into the entity embedding 128.

In some implementations, entity embedding generator 126 includes a fusion network that creates the final entity embedding 128 based on the one or more entity expertise embeddings 120. For example, entity embedding generator 126 uses concatenation or another type of combination function to join the one or more entity expertise embeddings 120 into the entity embedding 128.

Expertise model 110 or tower N 112 outputs entity embedding 128 for use by one or more downstream models, processes, components, networks, and/or systems. For example, Entity embedding 128 is used as an input to a task-specific prediction network. Dashed lines are used in FIG. 1 to shown that one or more downstream models, processes, components, networks, and/or systems can be implemented as part of expertise model 110 or can be separate from expertise model 110. For example, a task-specific prediction network that receives entity embedding 128 as an input can be implemented as part of expertise model 110 or as a separate model.

Entity embedding 128 is used by the one or more downstream models, processes, components, networks, and/or systems for, e.g., classification, scoring, ranking, sorting, or other downstream tasks. For example, entity embedding 128 can be used by a recommendation system to recommend a job candidate based upon the job candidate's level of expertise in a field that is relevant to a job posting because the entity embedding 128 encodes expertise information into the embedding using the techniques described above. Stated another way, after the expertise model 110 is trained, at inference time, the expertise model 110 can be used to determine whether two entities are a good match in terms of level of expertise. For instance, supposing the two entities to be compared are a query and a document, the expertise model 110 is capable of converting a query (e.g., a job candidate search query or an article) into a query embedding with the expertise information that is relevant to that query encoded in the query embedding. The expertise model 110 is also capable of converting a document (e.g., user profile information) into a document embedding with the user's level of expertise information that has been extracted from that document encoded into the document embedding. The query embedding and document embedding are then compared using a comparison function such as a dot product. The output of the comparison of the query embedding and the document embedding indicates a measurement of closeness or similarity of the two embeddings. For example, a comparison function is applied to the query embedding and the document embedding to produce a matching score. Based on the matching score computed for the query embedding and document embedding, a determination is made as to whether the document is a good match for the query.

As a further illustration, supposing that the two inputs to the expertise model 110 are a job search query and a user profile, the matching score computed based on the comparison of the job search query embedding and the user profile embedding is indicative of whether the user associated with the user profile is a good match for the job described in the job search query. Because the expertise model 110 encodes expertise information into each of the embeddings; e.g., the job search embedding includes information about the level of expertise required by the job and the user profile embedding includes information about the level of expertise possessed by the user associated with the user profile, the matching score is implicitly based on how well the expertise of the user matches the expertise required by the job.

Examples of downstream tasks for which the evidence-based expertise-informed entity embedding 128 can be used to improve the efficiency and reliability of information retrieval are provided below. These examples are illustrative and non-limiting. Other uses of the evidence-based expertise-informed entity embedding 128 are possible. For instance, output of the expertise model can be used to generate sets of relevant content items for selection by a user; for example, job postings that match a user's level of expertise or articles to which the user may like to contribute as a result of matching the user's expertise. In these and other ways, the expertise model output including entity expertise embeddings can be used to filter, modify, sort, group, or otherwise configure sets of content items for selection or manipulation by the user to, in turn, reduce the burden of user input to a computer because the user no longer needs to manually perform such operations using the computer.

Job Candidate Search: Users can identify qualified job candidates by issuing queries that contain single or multiple terms related to specific skill expertise. An entity expertise embedding is generated for the query, and an entity expertise embedding is generated for each user in a set of potential job candidates. The entity expertise embedding for the query is compared to the entity expertise embeddings for the users, to retrieve a list of users who possess the desired skill level of expertise.

Article Contribution: The entity expertise embeddings can be used to identify prospective contributors to an article, learning video, or other type of document that mentions multiple different skills or areas of expertise. By comparing expertise embeddings of the document and expertise embeddings of users, prospective contributors can be identified who have associated evidence of expertise in the skills or areas of expertise mentioned in the document.

Job Search: Expertise embeddings can be generated based on a user's query when the query contains one or more skill terms, alone or in combination with one or more skill-related features extracted from the user's profile. Expertise embeddings can be generated based on features extracted from job postings and descriptions of job requirements. The user's expertise embedding can be compared with the job posting expertise embeddings to identify and retrieve job postings that align with the user's skill set and levels of expertise.

Job Matching with Expertise: Expertise embeddings can be generated for job postings that contain specific skill and/or expertise requirements, and also for user profiles. The expertise embeddings of the job postings can be compared to the expertise embeddings for the users to generate recommended job opportunities that match the users' skill set and level of expertise.

Top Skills: Expertise embeddings can be generated for users based on the users' profiles, and expertise embeddings can be generated for skill or expertise descriptions, such as skill descriptions that may be obtained from or via a skill taxonomy. A user's skills or areas of expertise can be ranked and the user's top skills can be determined by comparing the expertise embeddings of the users' profiles with the expertise embeddings of the skill descriptions. These expertise embeddings can be used to rank expertise levels across skills, and/or to identify skills in which the users demonstrate the highest level of expertise.

Expertise Comparison: Expertise embeddings can be generated for multiple different users based on the respective user profiles and/or associated skill descriptions. A pairwise comparison of the expertise embeddings for the users can be used to determine the relative levels of expertise among the users.

The examples shown in FIG. 1 and the accompanying description, above are provided for illustration purposes. This disclosure is not limited to the described examples. Additional or alternative details and implementations are described herein.

FIG. 2 is a flow diagram of an example method for generating predictive output based on expertise embeddings using components of an expertise modeling system in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an expertise modeling system, including, in some embodiments, components shown in FIG. 2 that may not be specifically shown in one or more of the other figures, or by components of expertise modeling system 480 of FIG. 4, including, in some embodiments, components shown in FIG. 4 that may not be specifically shown in FIG. 2, or by components of any of computing systems 100, 300, 400, or 600, which may not be specifically shown in FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible. For example, in some embodiments, expertise embeddings are precomputed and stored for future inferencing by the expertise modeling system or one or more other downstream systems. For instance, expertise model 110 could ingest entity features 108 for each different user of an online system, generate an entity embedding 128 that encodes the user's expertise, and store the entity embeddings 128 for future use or at inference time. For example, when an application software system receives a query, an embodiment of expertise model 110 could be used to generate an entity embedding 128 for the query, the pre-computed stored entity embeddings for the users can be retrieved, and then each or any of the entity embeddings that encode the users' expertise can be compared to the entity embedding that encodes the expertise requested in the query to identify the users that best match the expertise requested by the query. An example of inference-time use of an embodiment of expertise model 110 is shown in FIG. 2, described below.

In FIG. 2, a computing system 200 performs operations associated with the generation of expertise embeddings and/or predictive output based on evidence-based features of a query and evidence-based features of an entity.

In computing system 200, an embodiment of expertise model 206 includes a query expertise tower 208, an entity expertise tower 210, and a prediction function or network 216. In some implementations, each of query expertise tower 208 and entity expertise tower 210 includes a neural network tower similar to tower N 112 of FIG. 1, described above, and prediction function or network 216 includes a prediction function, such as a similarity function or matching function, or a neural network layer such as a task-specific prediction network.

In the embodiment of FIG. 2, the designations of “query” and “entity” are for ease of discussion as this terminology can be applied to a wide variety of retrieval tasks. For example, in some retrieval tasks, “query” can refer to user input of a set of keywords or Boolean query containing one or more search terms while “entity” may refer to a target of the retrieval task, such as a document, article, job posting, or user profile. In other retrieval tasks, “query” can refer to an entity such as a user profile, an article or a job posting, while “entity” may refer to a target of the retrieval task, such as another entity or type of entity (e.g., another use profile, article, or job posting).

In some implementations, expertise model 206 includes an embedding-based retrieval model with a multi-tower architecture that supports a wide variety of use cases including the retrieval tasks described above. In each of the towers of the expertise model, multi-layer deep networks represent the spectrum of expertise using embeddings. The expertise model can share expertise knowledge across different entity-related tasks via multi-task learning during the model training process. The expertise embeddings output from each tower can be served as inputs for one or more of the information retrieval tasks.

In operation, a feature extractor 205 extracts query features 202 from query evidence 201 associated with a query ID and extracts entity features 204 from entity evidence 203 associated with an entity ID. Query evidence 201 and entity evidence 203 can be obtained, for example, from one or more of the expertise sources of evidence 102, described above, that match the query ID and entity ID, respectively. Alternatively, one or more of query evidence 201 or entity evidence 203 can be obtained from user input, e.g., via a user interface 412 of a user system 410, in which case an identifier (e.g., a query ID or entity ID) is assigned to the respective user input. For example, query evidence 201 can include search terms input by a user via a user interface 412 alone or in combination with one or more other pieces of data, such as contextual data associated with the query evidence 201. As another example, entity evidence 203 can include a document or a link to a document selected by a user via a user interface 412 alone or in combination with one or more other pieces of data, such as contextual data associated with the entity evidence 203.

Feature extractor 205 can be implemented as a single feature extractor 205 that operates similarly with respect to both query features 202 and entity features 204. Alternatively, feature extractor 205 can include multiple feature extractors that are each configured to extract a features from a particular type of evidence or for a particular type of task.

Feature extractor 205 outputs query features 202 based on query evidence 201 and outputs entity features 204 based on entity evidence 203. Each of query features 202 and entity features 204 can be formulated, for example, similar to entity features 108, described above. For instance, as shown in FIG. 2, query features 202 can be formatted as {queryID, evidence 1, . . . , evidenceN} where an item of evidence includes [a description of the evidence, a source of the evidence]. Similarly, entity features 204 can be formatted as {entityID, evidence 1, . . . , evidenceN} where an item of evidence includes [a description of the evidence, a source of the evidence]. In each case, the description of the evidence can include unstructured data and the source of the evidence can include a source identifier that identifies the source of the description of the evidence and/or a source confidence score associated with the source identifier.

In operation, query expertise tower 208 receives as input query features 202. Query expertise tower generates and outputs query expertise embedding 212 based on query features 202. Entity expertise tower 210 receives as input entity features 204. Entity expertise tower 210 generates and outputs entity expertise embedding 214 based on entity features 204. Each of query expertise embedding 212 and entity expertise embedding 214 can be formulated, for example, similar to entity embedding 128, described above. That is, query expertise embedding 212 and entity expertise embedding 214 each encode level of expertise information associated with the query ID and the entity ID, respectively.

Each of query expertise tower 208 and entity expertise tower 210 can be configured, for example, similar to the tower N 112 shown in FIG. 1, described above. For example, query expertise tower 208 and entity expertise tower 210 each can include a feature encoder, an expertise extractor coupled to output of the feature encoder 114, an expertise level predictor, and an entity embedding generator coupled to output of the expertise extractor.

Prediction function or network 216 receives as input query expertise embedding 212 and entity expertise embedding 214. Prediction function or network 216 performs an operation on query expertise embedding 212 and entity expertise embedding 214 and outputs a result of the operation as predictive output 218. For example, predictive function or network 216 can apply a similarity function to query expertise embedding 212 and entity expertise embedding 214, and output, as predictive output 218, a probability that the entity's level of expertise, as represented by the entity expertise embedding 214, matches a desired level of expertise, as represented by query expertise embedding 212. In some implementations, predictive function or network 216 performs a dot product or Hadamard product on query expertise embedding 212 and entity expertise embedding 214.

As shown in FIG. 2, outputs of expertise model 206 can include query expertise embedding 212, entity expertise embedding 214, and predictive output 218. Predictive output 218 can include an expertise score, e.g., a vector P(i), which represents a probabilistic or statistical likelihood that an expertise i is contained in the query expertise embedding 212 and/or the entity expertise embedding 214.

In some implementations, the expertise embeddings (e.g., entity expertise embeddings 120), query expertise embeddings 212, and entity expertise embeddings 214, are all projected onto the same embedding space. After the expertise embeddings are created, a retrieval step can take place in that embedding space using, for example, an approximate nearest neighbor (ANN) search algorithm.

As an illustrative, non-limiting use case, consider the example of a search for a job candidate to fill a job with a specific expertise requirement. In this scenario, the query expertise tower 208 encodes a search query identified by a query ID and generates a query expertise embedding 212. The entity expertise tower 210 encodes the profiles of N users of the online system who are potential job candidates, identified by entity IDs, respectively, and generates N entity expertise embeddings 214, respectively. In each case, the expertise embeddings capture and encode the levels of expertise contained in the respective evidence from which the respective embeddings have been created.

After the query expertise embedding and the set of N entity expertise embeddings are created, a retrieval step is performed in the embedding space. In the retrieval step, the nearest neighbors to the query expertise embedding from among the entity expertise embeddings are identified. This approach enables effective matching of queries with entities based on level of expertise evidence.

In some implementations, the predictive output 218 includes a sparse expertise scoring vector P. The sparse expertise scoring vector possesses a rich interpretation in that, when provided with an entity ID, the retrieval step can use the expertise embedding to quickly determine the top areas of expertise of the entity by looking up the vector P associated with the entity ID.

Expertise model 206 is coupled to a model serving component 220. Model serving component 220 connects the output of expertise model 206 to one or more downstream processes, components, networks, and/or systems.

For example, expertise model 206 can function as a first-pass ranker that provides relevant entities for different downstream applications related to expertise. For specific use cases, because of the more subtle requirements of the individual use cases, a second-pass ranker may be used for finer-grain re-ranking of the entities provided by the expertise model 206.

To serve the expertise model 206, model serving component 220 can provide expertise model 206, for example as an online service that users of the model can load and integrate into their own serving pipelines for scoring and/or other purposes. Alternatively or in addition, model serving component 220, provides expertise model 206 via an offline scoring pipeline with a desired scoring cadence to compute and store the expertise embeddings and/or push the expertise embeddings from an offline data store to a real-time data store. Additionally or alternatively, model serving component 220 provides expertise model 206 via a nearline scoring pipeline.

In some implementations, model serving component 220 builds, stores, and maintains an index of expertise embeddings such that, during a retrieval step, a nearest neighbor search technique can be applied to the index for fast retrieval of the K nearest neighbors in the embedding space.

The examples shown in FIG. 2 and the accompanying description, above are provided for illustration purposes. This disclosure is not limited to the described examples.

FIG. 3 is a flow diagram of an example method for training an expertise model using components of an expertise modeling system in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an expertise modeling system, including, in some embodiments, components shown in FIG. 3 that may not be specifically shown in one or more of the other figures, or by components of expertise modeling system 480 of FIG. 4, including, in some embodiments, components shown in FIG. 4 that may not be specifically shown in FIG. 3, or by components of any of computing systems 100, 200, 400, or 600, which may not be specifically shown in FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 3, a computing system 300 performs operations associated with the training of an expertise model 318 using, for example, multi-task, multi-objective supervised machine learning. The computing system 300 includes a training data generator 306, an expertise model 318, and a decision component 344.

Training data generator 306 is configured to generate and output training data based on expertise evidence data 304 extracted from expertise evidence sources 302. Expertise evidence sources 302 and expertise evidence data 304 can be, for example, part of or similar to expertise evidence sources 102 and entity evidence 104 of FIG. 1, described above, except that expertise evidence sources 302 and expertise evidence data 304 may or may not be associated with or filtered by any particular entity IDs or source confidence scores at the outset.

Training data generator 306 includes an evidence extractor 308, a labeling component 310, and a filtering component 312. Evidence extractor 308 executes one or more queries on one or more of expertise evidence sources 302 to obtain samples of expertise evidence data 304 from the one or more expertise evidence sources 302.

Labeling component 310 assigns a label to each sample of expertise evidence data 304. The label assigned to each sample of expertise evidence data 304 by labeling component 310 corresponding to a level of expertise represented by the particular sample of expertise evidence data 304. For example, a label can include a domain and/or a description of expertise extracted from the sample of expertise evidence data 304 along with an associated attribute value, such as a skill category. For instance, a label for a piece of evidence can be formatted as [expertise, label], e.g., [JavaScript, expert] or [Mergers and Acquisitions, Senior Partner], or [French Cuisine, 10]. As noted above, the expertise labels can be expressed in any suitable format depending on the requirements of a particular design or implementation. For example, an expertise label could be an integer value in the range of one to ten, with ten being the highest level of expertise and one being the lowest level of expertise. Through the iterative training processes, the expertise model 318 can machine learn many different ways in which levels of expertise can be labeled in many different domains, the differences between level of expertise labeling across many different domains, and the source confidence scores associated with different types of evidence.

A label confidence score associated with the label can be included in the label or as a separate element of the training data. For example, while the label indicates a particular level of expertise associated with a particular attribute value (e.g., a skill), the label confidence score indicates the likelihood that the label is accurate based on the associated item of evidence. The label confidence score can include or correlate with one or more of the source confidence scores. For example, a label confidence score can include a source entity reputation score and/or a source type reliability score, or a source usefulness score. Alternatively or in addition, the label confidence score can be assigned, or reviewed and validated, by a human expert based on observation during training data preparation and/or one or more source confidence scores or other information. An example format for an instance of labeled training data is {evidence, label, label confidence score} where an item of evidence includes [evidence description, source ID] and a label includes [expertise, level].

In some embodiments, labeling component 310 uses a generative language model, such as a large language model, to generate labels for the samples of expertise evidence data 304. For example, labeling component 310 configures a prompt that instructs a large language model to extract a domain and/or description of expertise from each sample of expertise evidence data 304 and output the extracted content as a label. Other entity extraction techniques can also or alternatively be used by labeling component 310 to automate the process of labeling the expertise evidence data 304.

Filtering component 312 filters the expertise evidence data 304 based on one or more filtering criteria. Examples of filtering criteria that can be used by filtering component to filter the expertise evidence data 304 include threshold source confidence scores and domain labels. For example, filtering component 312 can ensure that the training data used to train or fine tune expertise model 318 only includes expertise evidence data obtained from sources with source confidence scores that exceed the associated threshold source confidence scores. As another example, filtering component 312 can filter the training data so that training or fine tuning of expertise model 318 is limited only to a specific domain or set of specific domains.

In the example of FIG. 3, training data generator 306 is configured to generate and output multiple different types of training data including expertise evidence training data 314 and task-specific tuning data 316. For example, expertise evidence training data 314 can be used to train expertise model 318 in a pre-training stage while task-specific tuning data 316 can be used to fine-tune a pre-trained version of expertise model 318 or a portion of a pre-trained version of expertise model 318 for a specific task or tasks, such as one or more of the information retrieval task use cases described herein.

In the example of FIG. 3, expertise model 318 includes multiple towers, including a task 1 query tower 320, a task N query tower 322, an entity 1 tower 324 and an entity N tower 326, where N is a positive integer (it should be noted that the various uses of the term N are throughout this disclosure to be interpreted in context and do not necessarily designate the same value; for example, the total number of tasks N served by the expertise model 318 can be different from the total number of entities N which can be different from the total number of towers N. Each of the towers 320, 322, 324, 326 can be configured, for example, according to the neural network architecture of tower N 112 of FIG. 1, described above. As described in more detail below, each of the towers 320, 322, 324, 326 has an associated multi-objective loss function (MO LF) 328, 330, 332, 334.

In the example of FIG. 3, one or more task-specific prediction components 336, 338 are coupled to output of one or more of the towers 320, 322, 324, 326. For example, a task-specific prediction component 336, 338 can be configured as or in a similar manner to the prediction function or network 216, described above. For instance, a task-specific prediction component 336, 338 can be a version of the prediction function or network 216 that has been modified or adapted to a specific type of information retrieval task or use case. As described in more detail below, each of the one or more task-specific prediction components 336, 338 has an associated task-specific objective loss function (TSO LF) 340, 342.

During training or tuning, the output of the loss functions is periodically evaluated at decision component 344. Based on the loss function output, decision component 344 determines whether to continue training or tuning the expertise model 318 with additional training data samples or to discontinue the training or tuning. If the decision component 344 determines to continue training or tuning expertise model 318, the flow returns to training data generator 306. If the decision component 344 determines not to continue training or tuning expertise model 318, the flow may proceed to a validation phase and/or a deployment phase in which the trained and/or tuned expertise model 318 is validated and once validated, made available for use via, e.g., model serving component 220 of FIG. 2, described above.

As shown in FIG. 3, the training of expertise model 318 can include pre-training and fine-tuning stages. In a pre-training stage, the feature encoders (e.g., feature encoder 114) of the towers 320, 322, 324, 326 are initialized. A publicly pretrained checkpoint version of the feature encoder 114 can be used for initialization or the feature encoders can be initialized with random initial parameter values.

The expertise model 318 is then trained using a large-scale corpus of training data 314 which can contain unstructured expertise evidence data 304 such as entity profiles, published resumes, published articles, search queries, job postings, etc. Using E; to represent an individual embedding of an expertise i (e.g., an entity expertise embedding 120 shown in FIG. 1), the probability that expertise i is contained in the input data received by a tower 320, 322, 324, 326 can be formulated as P(i)=σ(Uᵢ^{T}Eᵢ+bᵢ) where σ( ) denotes the sigmoid function, and Uᵢ and bᵢ are expertise learning parameters that are initialized randomly and shared among the feature encoders of the query towers 320, 322 and entity towers 324, 326. The expertise score regression loss, which is a weighted cross entropy function Lⁱ_{EXP}=−γᵢ log (P(i)) where yᵢ∈[0,1], is a known expertise score which can be initialized from the pre-trained model or obtained by human annotation.

The multi-objective loss function (MO LF) is a pre-training loss function that combines a standard masked language loss L_{MLM} and the expertise score regression loss L_{EXP} as: L_{MLM}+Σᵢ₌₁^{|A|} L_{EXP}ⁱ=αΣᵢ₌₁^{|A|} P(i), where the third term is a LASSO (Least Absolute Shrinkage and Selection Operator) regularizer that ensures the sparseness of the learned scores for better expertise selection and interpretation. In the expertise score regression loss equation, A is the number of the cardinality of a specific desired type of expertise. For example, if the application domain is job search then the desired type of expertise could be “skill expertise.” Supposing that in this example the number of possible data values for “skill expertise” is 40,0000 (e.g., there are 40,000 different skill labels in a set of possible skill labels, such as a taxonomy), then the value of A would be set to 40,000. The value of A is adjustable depending on the requirements of a particular design or implementation. Also in the expertise score regression loss equation, alpha (a) is a weight coefficient that is part of the LASSO regularization term. The LASSO regularization term is used to prevent the model from overfit and/or underfit, and the value of alpha controls the degree of overfit or underfit. For example, if alpha is set to zero, the LASSO regularization term goes to zero and the model could overfit. If alpha is too large then the LASSO regularization term has too much weight and the model could under fit.

As used herein, overfit can occur when the model output is reliable for input that is very similar to the data used to train the model but is not reliable for new data that the model hasn't been trained with (e.g., the model cannot generalize and fits too closely to the training dataset. Underfit can occur when the data used to train the model does not adequately capture the complexities in the data the model is likely to receive as input at inference time, or the model is oversimplified so that it is incapable of capturing complexities in the input data. Either overfit or underfit can cause the model to produce inaccurate predictions. As such, the value of alpha and/or other parameters can be iteratively adjusted during training until an acceptable prediction accuracy or reliability is achieved. The exact parameter values and number of training iterations required to produce a version of the model that can be used for inferencing can vary based on the requirements of a particular design or implementation. This configuration of multiple objectives in the multi-objective loss function allows the expertise model 318 to learn to capture the distribution of query/entity inputs and also to understand the expertise expressed in the inputs.

In a fine-tuning stage, the expertise model 318 is optimized with a combination of task-specific multi-task objectives via the task-specific loss function (TSO LF). Each task in the multi-task setting includes multiple types of objectives: (a) the cross-entropy loss L_{CE} for predicting the relevance of a query-entity pair, where the pairs are derived from expertise evidence data from various sources related to various retrieval tasks or use cases; and (b) the in-batch softmax cross-entropy loss L_{SCE}, which leverages random negatives from the training batch. A small amount of expertise prediction loss, which is controlled by the value of a hyperparameter λ, can also be introduced in the fine-tuning stage as: L_{CE}+L_{SCE}+λΣᵢ₌₁^{|A|} L_{EXP}ⁱ.

The examples shown in FIG. 3 and the accompanying description, above are provided for illustration purposes. This disclosure is not limited to the described examples.

FIG. 4 is a block diagram of a computing system that includes an expertise modeling system in accordance with some embodiments of the present disclosure.

In the embodiment of FIG. 4, a computing system 400 includes one or more user systems 410, a network 420, an application software system 430, an expertise modeling system 480, a data storage system 450, one or more downstream application systems 460, and an event logging service 470.

In some implementations, all or at least some components of expertise modeling system 480 are implemented at the user system 410. For example, user interface 412 and expertise modeling system 480 are implemented directly upon a single client device such that communications between user interface 412 and expertise modeling system 480 occur on-device without the need to communicate with, e.g., one or more servers, over the Internet. Dashed lines are used in FIG. 4 to indicate that all or portions of expertise modeling system 480 can be implemented directly on the user system 410, e.g., the user's client device. In other words, both user system 410 and expertise modeling system 480 can be implemented on the same computing device.

In other implementations, all or portions of expertise modeling system 480 are implemented on one or more back end systems or servers, for example as a network service or as a component of application software system 430. Components of the computing system 400 including the expertise modeling system 480 are described in more detail herein.

A user system 410 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 410 can be connected to network 420 at the same time or at different times. Different user systems 410 can contain similar components as described in connection with the illustrated user system 410. For example, many different end users of computing system 400 can be interacting with many different instances of application software system 430 through their respective user systems 410, at the same time or at different times.

User system 410 includes a user interface 412. User interface 412 is installed on or accessible to user system 410 by network 420. User interface 412 enables user interaction with the application software system 430 and in some cases, portions of expertise modeling system 480.

User interface 412 includes, for example, a graphical display screen that includes graphical user interface elements such as at least one input box or other input mechanism and at least one slot. A slot as used herein refers to a space on a graphical display such as a web page or mobile device screen, into which digital content such as threads can be loaded for display to the user. For example, user interface 412 may be configured with a scrollable arrangement of variable-length slots that displays content and/or dialog in a feed, a search interface, a web application, an online chat or an instant messaging format. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

User interface 412 enables the user to upload, download, receive, send, or share of various types of digital content items, including posts, articles, comments, and shares, to initiate user interface events, and to view or otherwise perceive, edit or manipulate digital output such as data and/or digital content produced by application software system 430, user connection network 436, search engine 440, expertise modeling system 480, and/or content distribution service 438. For example, user interface 412 can include a graphical user interface (GUI), a conversational voice/speech interface, a virtual reality, augmented reality, or mixed reality interface, and/or a haptic interface. User interface 412 includes a mechanism for logging in to application software system 430, clicking or tapping on GUI user input control elements, and interacting with digital content items. Examples of user interface 412 include web browsers, command line interfaces, and mobile app front ends. User interface 412 as used herein can include application programming interfaces (APIs).

In the example of FIG. 4, user interface 412 includes a front end user interface component of application software system 430 or expertise modeling system 480. For example, user interface 412 can be integrated with any other user interface of application software system 430. Access to user interface 412 can be limited to specific user systems 410. For example, in some implementations, access to user interface 412 is limited to registered users of application software system 430 or to permitted users of expertise modeling system 480.

Network 420 includes an electronic communications network. Network 420 can be implemented on any medium or mechanism that provides for the exchange of digital data, signals, and/or instructions between the various components of computing system 400. Examples of network 420 include, without limitation, a Local Area Network (LAN), a Wide Area Network (WAN), an Ethernet network or the Internet, or at least one terrestrial, satellite or wireless link, or a combination of any number of different networks and/or communication links.

Application software system 430 includes any type of application software system that provides or enables the creation, upload, and/or distribution of at least one form of digital content between or among user systems, such as user system 410, via user interface 412. In some implementations, portions of expertise modeling system 480 are components of application software system 430. Embodiments of application software system 430 can include or interface with various components such as an entity graph 432 and/or knowledge graph 434, a user connection network 436, a content distribution service 438, and a search engine 440.

In the example of FIG. 4, application software system 430 includes the entity graph 432 and/or knowledge graph 434. Entity graph 432 and/or knowledge graph 434 include data organized according to graph-based data structures that can be traversed via queries and/or indexes to determine relationships between entities. For instance, entity graph 432 and/or knowledge graph 434 can be used to compute various types of relationship weights, affinity scores, similarity measurements, and/or statistics between, among, or relating to entities.

Entity graph 432 and/or knowledge graph 434 includes a graph-based representation of data stored in data storage system 450, described herein. For example, entity graph 432 and/or knowledge graph 434 represents entities, such as users, organizations (e.g., companies, schools, institutions), and content items (e.g., job postings, announcements, articles, comments, and shares, as nodes of a graph. Entity graph 432 and/or knowledge graph 434 represents relationships, also referred to as mappings or links, between or among entities as edges, or combinations of edges, between the nodes of the graph. In some implementations, mappings between different pieces of data used by application software system 430 are represented by one or more entity graphs. In some implementations, the edges, mappings, or links indicate online interactions or activities relating to the entities connected by the edges, mappings, or links. For example, if a user applies for a job, an edge may be created connecting the user entity with the job entity in the entity graph, where the edge may be tagged with a label such as “applied.”

Portions of entity graph 432 and/or knowledge graph 434 can be automatically re-generated or updated from time to time based on changes and updates to the stored data, e.g., updates to entity data and/or activity data. Also, entity graph 432 and/or knowledge graph 434 can refer to an entire system-wide entity graph or to only a portion of a system-wide graph. For instance, entity graph 432 and/or knowledge graph 434 can refer to a subset of a system-wide graph, where the subset pertains to a particular user or group of users of application software system 430.

In some implementations, knowledge graph 434 is a subset or a superset of entity graph 432. For example, in some implementations, knowledge graph 434 includes multiple different entity graphs 432 that are joined by cross-application or cross-domain edges. For instance, knowledge graph 434 can join entity graphs 432 that have been created across multiple different databases or across different software products. In some implementations, the entity nodes of the knowledge graph 434 represent concepts, such as product surfaces, verticals, or application domains. In some implementations, knowledge graph 434 includes a platform that extracts and stores different concepts that can be used to establish links between data across multiple different software applications. Examples of concepts include topics, industries, and skills. The knowledge graph 434 can be used to generate and export content and embeddings that can be used to discover or infer new interrelationships between entities and/or concepts, which then can be used to identify related or matching entities. As with other portions of entity graph 432, knowledge graph 434 can be used to compute various types of relationship weights, affinity scores, similarity measurements, and/or statistical correlations between or among entities and/or concepts.

User connection network 436 includes, for instance, a social network service, professional social network software and/or other social graph-based applications. Content distribution service 438 includes, for example, a news feed, a chatbot or chat-style system, a messaging system, such as a peer-to-peer messaging system that enables the creation and exchange of messages among users of application software system 430, or a combination of any of the foregoing. Search engine 440 includes a search engine that enables users of application software system 430 to input and execute search queries on user connection network 436 and/or entity graph 432 and/or knowledge graph 434 and/or other data sources, such as web pages or indexes. In some implementations, one or more portions of user interface 412 are in bidirectional communication with one or more of user connection network 436, content distribution service 438, or search engine 440. Application software system 430 can include, for example, online systems that provide social network services, general-purpose search engines, specific-purpose search engines, messaging systems, content distribution platforms, e-commerce software, enterprise software, or any combination of any of the foregoing or other types of software.

In some implementations, a front end portion of application software system 430 can operate in user system 410, for example as a plugin or widget in a graphical user interface of a web application, mobile software application, or as a web browser executing user interface 412. In an embodiment, a mobile app or a web browser of a user system 410 can transmit a network communication such as an HTTP request over network 420 in response to user input that is received through a user interface provided by the web application, mobile app, or web browser, such as user interface 412. A server running application software system 430 can receive the input from the web application, mobile app, or browser executing user interface 412, perform at least one operation using the input, and return output to the user interface 412 using a network communication such as an HTTP response, which the web application, mobile app, or browser receives and processes at the user system 410.

In the example of FIG. 4, application software system 430 includes the content distribution service 438. The content distribution service 438 can include a data storage service, such as a web server, which stores digital content items, and transmits digital content items, such as articles and job postings, to users based on output of expertise modeling system 480. In some embodiments, content distribution service 438 processes input from, for example, application software system 430 and/or expertise modeling system 480, and distributes digital content items to user systems 410 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, content distribution service 438 is part of application software system 430. In other implementations, content distribution service 438 interfaces with application software system 430 and/or expertise modeling system 480, for example, via one or more application programming interfaces (APIs).

In the example of FIG. 4, application software system 430 includes the search engine 440. Search engine 440 is a software system designed to search for and retrieve information by executing queries on data stores, such as databases, connection networks, and/or graphs. The queries are designed to find information that matches specified criteria, such as keywords and phrases. For example, search engine 440 is used to retrieve data by executing queries on various data stores of data storage system 450 or by traversing entity graph 432, 434.

Data storage system 450 includes data stores and/or data services that store digital data received, used, manipulated, and produced by application software system 430 and/or expertise modeling system 480, including entity data, activity data, machine learning model training data, machine learning model parameters, and machine learning model inputs and outputs, including predictive output such as comparisons, rankings, scores, classifications, and/or recommendations.

In the example of FIG. 4, data storage system 450 includes an entity data store 452, an activity data store 454, and a model data store 456. Entity data store 452 stores data relating to users, companies, jobs, and other entities, such as profile data, which are used by the expertise modeling system 480 to, for example, generate embeddings and/or compute weights, statistics, similarity measurements, or scores. Activity data store 454 stores data relating to network activity, e.g., user interface event data extracted from application software system 430 and/or user interface 412 by event logging service 470, which are used by the expertise modeling system 480 to, for example, generate embeddings and/or compute weights, statistics, similarity measurements, or scores. Model data store 456 stores data that can be used to configure, train or tune one or more machine learning models of the expertise modeling system 480.

In some embodiments, data storage system 450 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 450 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 450 resides on at least one persistent and/or volatile storage device that can reside within the same local network as at least one other device of computing system 400 and/or in a network that is remote relative to at least one other device of computing system 400. Thus, although depicted as being included in computing system 400, portions of data storage system 450 can be part of computing system 400 or accessed by computing system 400 over a network, such as network 420.

A downstream system 460 includes one or more models, processes, components, networks, and/or systems that access and use output of the expertise modeling system 480, such as entity embeddings, entity expertise embeddings, and/or level of expertise data, to perform one or more functions. The downstream system 460 is communicatively coupled to the expertise modeling system 480 via network 420. For example, a downstream system 460 can use expertise embeddings and/or level of expertise data output by the expertise modeling system 480 as input into decision logic such that the downstream system 460 executes different processes when the downstream system 460 receives different values of the level of expertise data from the expert modeling system 480. For example, the downstream system 460 can include logic that determines which of a set of possible operations to execute based on the output of the expert modeling system 480. A downstream system 460 can be a component of application software system 450 or another system or application that is not part of application software system 450. A downstream system 460 can be or include a machine learning model training system and/or a trained machine learning model. Examples of downstream systems 460 include domain specific search verticals within a search engine. Other examples of downstream systems 460 include domain-specific content distribution platforms such as online learning platforms, messaging systems, video players, and audio players.

Event logging service 470 captures and records network activity data generated during operation of application software system 430 and/or expertise modeling system 480, including user interface events generated at user systems 410 via user interface 412, in real time, and formulates the user interface events into a data stream that can be consumed by, for example, a stream processing system. Examples of network activity data include views, page loads, clicks on messages or graphical user interface control elements, the creation, editing, sending, and viewing of content, and social action data such as likes, shares, comments, and social reactions (e.g., “insightful,” “curious,” etc.). For instance, when a user of application software system 430 via a user system 410 creates a post, views an item in a news feed, or clicks on a user interface element, such as a content item, a link, or a user interface control element such as a view, comment, share, or reaction button, or uploads a file, or creates a message, loads a web page, or scrolls through a feed, etc., event logging service 470 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a user creates a post, submits an online job application, or reacts to an item in a news feed, event logging service 470 stores the corresponding event data in a log. Event logging service 470 generates a data stream that includes a record of real-time event data for each user interface event that has occurred. Event data logged by event logging service 470 can be pre-processed and anonymized as needed so that it can be used, for example, to generate relationship weights, affinity scores, similarity measurements, and/or to formulate training data for artificial intelligence models in accordance with the applicable rules, regulations, or terms of use of the application software system 430.

The expertise modeling system 480 creates and trains expertise models as described herein, and serves trained expertise models for use in generating embeddings and/or predictive output as described herein. In the example of FIG. 4, expertise modeling system 480 includes a feature extractor 482, an expertise model 484, a model training component 486, and a model serving component 488. Feature extractor 482 extracts entity features from, for example, unstructured data sources, and formulates the extracted features for input to expertise model 484, as described herein. Feature extractor 106, described above with reference to FIG. 1, is an example of a feature extractor 482.

Expertise model 484 generates entity expertise embeddings based on entity features provided by feature extractor 482. Alternatively or in addition to the entity expertise embeddings, expertise model 484 can generate predictive output based on the entity expertise embeddings. For example, expertise model 484 can generate predictive output that matches, scores, or ranks entities or pairs of entities according to the level of expertise encoded in the entity expertise embeddings. Expertise models 110, 206, 318, described above with reference to FIG. 1, FIG. 2, and FIG. 3, respectively, are examples of an expertise model 484.

Model training component 486 trains expertise model 484 to learn entity expertise embeddings using a supervised learning approach based on labeled training data. Embodiments of model training component 486 can include training data generator 306 and/or perform the method shown in FIG. 3, described above.

Model serving component 488 serves trained versions of expertise model 484 for use in generating entity embeddings, expertise embeddings, and/or predictive output, as described herein. Model serving component 220, described above with reference to FIG. 2, is an example of a model serving component 488.

While not specifically shown, it should be understood that any of user system 410, application software system 430, expertise modeling system 480, data storage system 450, downstream system 460, and event logging service 470 includes an interface embodied as computer programming code stored in computer memory that when executed causes a computing device to enable bidirectional communication with any other of user system 410, application software system 430, expertise modeling system 480, data storage system 450, downstream system 460, or event logging service 470 using a communicative coupling mechanism. Examples of communicative coupling mechanisms include network interfaces, inter-process communication (IPC) interfaces and application program interfaces (APIs).

Each of user system 410, application software system 430, expertise modeling system 480, data storage system 450, downstream system 460, and event logging service 470 is implemented using at least one computing device that is communicatively coupled to electronic communications network 420. Any of user system 410, application software system 430, expertise modeling system 480, data storage system 450, downstream system 460, and event logging service 470 can be bidirectionally communicatively coupled by network 420. User system 410 as well as other different user systems (not shown) can be bidirectionally communicatively coupled to application software system 430 and/or expertise modeling system 480.

A typical user of user system 410 can be an administrator or end user of application software system 430 or expertise modeling system 480. User system 410 is configured to communicate bidirectionally with any of application software system 430, expertise modeling system 480, data storage system 450, downstream system 460, and event logging service 470 over network 420.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 410, application software system 430, expertise modeling system 480, data storage system 450, downstream system 460, and event logging service 470 are implemented using computer software, hardware, or software and hardware, and can include combinations of automated functionality, data structures, and digital data, which are represented schematically in the figures. User system 410, application software system 430, expertise modeling system 480, data storage system 450, downstream system 460, and event logging service 470 are shown as separate elements in FIG. 4 for ease of discussion but, except as otherwise described, the illustration is not meant to imply that separation of these elements is required. The illustrated systems, services, and data stores (or their functionality) of each of user system 410, application software system 430, expertise modeling system 480, data storage system 450, downstream system 460, and event logging service 470 can be divided over any number of physical systems, including a single physical computer system, and can communicate with each other in any appropriate manner.

In the embodiment of FIG. 4, portions of user interface 412 and expertise modeling system 480 may be collectively represented as expertise modeling system 480 for ease of discussion only. User interface 412 and expertise modeling system 480 are not required to be implemented all on the same computing device, in the same memory, or loaded into the same memory at the same time. For example, access to user interface 412 and/or expertise modeling system 480 can be limited to different, mutually exclusive sets of user systems and/or servers.

For instance, in some implementations, a separate, personalized version of expertise modeling system 480 is created for each user of the expertise modeling system 480 such that data is not shared between or among the separate, personalized versions of the system 480. Additionally, user interface 412 typically may be implemented on user systems while expertise modeling system 480 typically may be implemented on a server computer or group of servers. In some embodiments, however, one or more portions of expertise modeling system 480 are implemented on user systems. For example, both user interface 412 and expertise modeling system 480 are implemented on user systems, e.g., client devices, in some implementations. Further details with regard to the operations of expertise modeling system 480 are described herein.

The examples shown in FIG. 4 and the accompanying description, above are provided for illustration purposes. This disclosure is not limited to the described examples.

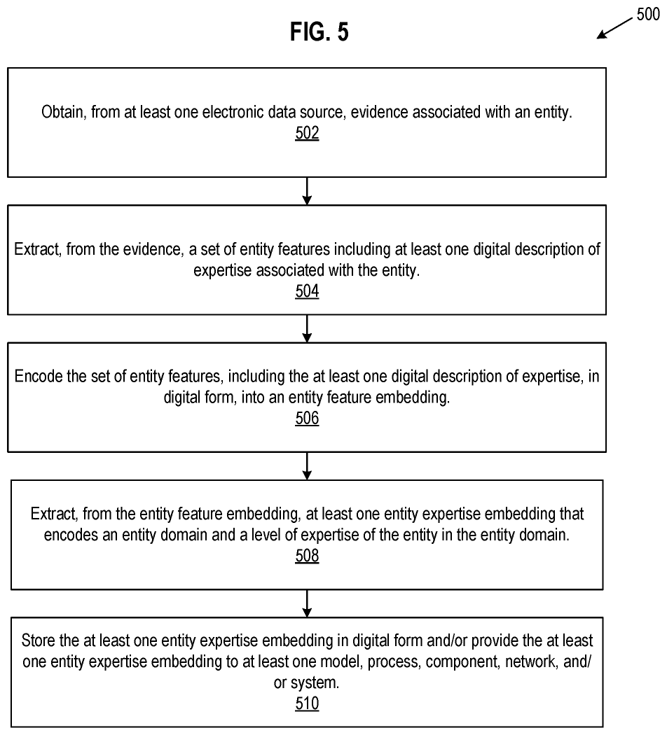

FIG. 5 is a flow diagram of an example method for generating and outputting entity embeddings using components of an expertise modeling system in accordance with some embodiments of the present disclosure.

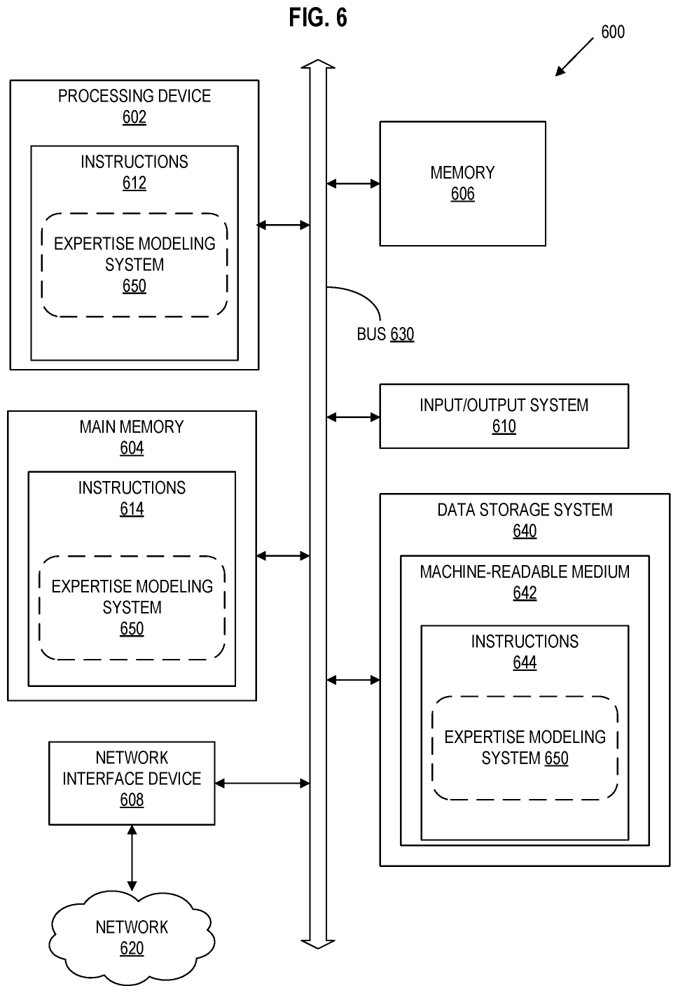

The method 500 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by one or more components of an expertise modeling system of computing system 100, 200, or 300, or expertise modeling system 480 of FIG. 4, or expertise modeling system 650 of FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 502, the processing device obtains, from at least one electronic data source, evidence associated with an entity. In some implementations, operation 502 includes obtaining evidence that includes unstructured data associated with an entity. Operation 502 is performed, for example, by feature extractor 106 shown in FIG. 1 or feature extractor 205 shown in FIG. 2, described herein.

In some implementations, operation 502 includes obtaining evidence for an entity, where the entity includes a user of an online system, a prospective contributor to an online article, a prospective candidate for an online job opening, an organization, company, or institution, or an article, document, video, audio file, or image.

At operation 504, the processing device extracts, from the evidence obtained at operation 502, a set of entity features including at least one digital description of expertise associated with the entity. In some implementations, operation 504 for is performed, for example, by feature extractor 106 shown in FIG. 1 or feature extractor 205 shown in FIG. 2, described herein. In some implementations, at least one digital description of expertise associated with the entity includes at least one of: at least a portion of an online user profile of the entity including at least one skill description, experience, education, job title, company name, certification, achievement, or award, an electronic submission by the entity related to an online job posting, an article, post, share, reaction, edit, or comment published by the entity via an online system, an article, post, share, reaction, edit, or comment published via an online system by a different entity about the entity, online activity of the entity, or online activity of the different entity that relates to the entity.

At operation 506, the processing device encodes the set of entity features extracted at operation 504, including the at least one digital description of expertise, in digital form, into an entity feature embedding. In some implementations, operation 506 is performed, for example, by feature encoder 114 shown in FIG. 1 and described herein.

In some implementations, encoding the set of entity features is performed by an expertise model. In some implementations, the expertise model is trained on a set of training examples. The set of training examples includes at least one training example that includes evidence of expertise in a domain, a label including the domain, and predictive data including a likelihood that the evidence indicates a level of expertise in the domain. In some implementations, the expertise model includes a neural network model. In some implementations, the neural network model includes an encoder network, and the encoding the set of entity features is performed by the encoder network.

At operation 508, the processing device extracts, from the entity feature embedding of operation 506, at least one entity expertise embedding that encodes an entity domain and a level of expertise of the entity in the entity domain. In some implementations, operation 506 is performed, for example, by expertise extractor 118 in cooperation with expertise level predictor 122, shown in FIG. 1 and described herein.

In some implementations, the at least one entity expertise embedding extracted at operation 508 includes a probability that the entity includes the level of expertise in the entity domain. In some implementations, extracting the at least one entity expertise embedding is performed by an expertise model. In some implementations, the expertise model is trained on a set of training examples. The set of training examples includes at least one training example that includes evidence of expertise in a domain, a label including the domain, and predictive data that includes a likelihood that the evidence indicates a level of expertise in the domain.

In some implementations, the expertise model includes a neural network model. In some implementations, the neural network model includes an attention network coupled to output of the encoder network, and the extracting the at least one entity expertise embedding is performed by the attention network.

At operation 510, the processing device stores the at least one entity expertise embedding in digital form and/or provide the at least one entity expertise embedding to at least one model, process, component, network, system, or any combination of any of the foregoing. In some implementations, operation 510 is performed, for example, by expertise model 110 shown in FIG. 1, expertise model 206 shown in FIG. 2, expertise model 318 shown in FIG. 3, or model serving component 220 shown in FIG. 2, described herein.

In some implementations, the neural network model includes a fusion network coupled to output of the attention network, and the fusion network combines entity expertise embeddings extracted from the entity feature embedding of operation 506 into the entity embedding.

In some implementations, the method 500 includes encoding a query, in digital form, into a feature embedding; extracting, from the feature embedding, at least one query expertise embedding that encodes a query domain, a level of expertise in the query domain, and a probability that the query includes the level of expertise in the query domain; storing the at least one query expertise embedding in digital form as a query embedding; and generating digital output based on a comparison of the query embedding to the entity embedding.

In some implementations, the encoding the set of entity features, the extracting the at least one entity expertise embedding, and combining at least one entity expertise embedding extracted from the entity feature embedding are performed by a first tower of a neural network model, the encoding the query and the extracting the at least one query expertise embedding are performed by a second tower of the neural network model, and the first and second towers of the neural network model are trained on a plurality of training examples, where a training example of the plurality of training examples includes evidence of expertise in a domain, a label including the domain, and predictive data including a likelihood that the evidence indicates a level of expertise in the domain.

In some implementations, the neural network model includes at least one task-specific component coupled to the first tower and the second tower, and the at least one task-specific component is fine-tuned to generate task-specific output based on at least the entity embedding including the at least one entity expertise embedding and the query embedding including the at least one query expertise embedding. In some implementations, the task-specific output includes at least one of: an indication that an entity expertise matches a query expertise, a ranking of entities based on a level of expertise, or a ranking of domains of expertise for an entity based on a level of expertise.

In some implementations, the query includes at least one of: a search for at least one entity that has a level of expertise that matches a level of expertise associated with the query, a request for a ranking of entities based on a level of expertise, a request for a ranking of domains of expertise for an entity based on a level of expertise, a document including a description of expertise, or a job description.

The examples shown in FIG. 5 and the accompanying description, above are provided for illustration purposes. This disclosure is not limited to the described examples.

FIG. 6 is a block diagram of an example computer system including components of an expertise modeling system in accordance with some embodiments of the present disclosure.

In FIG. 6, an example machine of a computer system 600 is shown, within which a set of instructions for causing the machine to perform any of the methodologies discussed herein can be executed. In some embodiments, the computer system 600 can correspond to a component of a networked computer system (e.g., as a component of the computing system 100 of FIG. 1 or the computing system 200 of FIG. 2 or the computing system 300 of FIG. 3 or the computer system 400 of FIG. 4), which includes, is coupled to, or utilizes a machine to execute operations corresponding to one or more components of the computing system 100 of FIG. 1 or the computing system 200 of FIG. 2 or the computing system 300 of FIG. 3 or the computer system 400 of FIG. 4. For example, computer system 600 corresponds to a portion of computing system 100, 200, 300, or 400 when the computing system is executing a portion or component of a feature extractor 106, an expertise model 110, an expertise model 206, a model serving component 220, an expertise model training data generator 306, an expertise model 318, or an expertise modeling system 650.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a memory 606 (e.g., flash memory, static random access memory (SRAM), etc.), an input/output system 610, and a data storage system 640, which communicate with each other via a bus 830.

Processing device 602 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be at least one special-purpose processing device such as an application specific integrated circuit (ASIC), a field programmable gate array (FPGA), a digital signal processor (DSP), network processor, or the like. The processing device 602 is configured to execute instructions 612 for performing the operations and steps discussed herein.

In some embodiments of FIG. 6, expertise modeling system 650 represents portions of expertise modeling system 480 when the computer system 600 is executing those portions of expertise modeling system 480. Instructions 612 include portions of expertise modeling system 650 when those portions of the expertise modeling system 650 are being executed by processing device 602. Thus, the expertise modeling system 650 is shown in dashed lines as part of instructions 612 to illustrate that, at times, portions of the expertise modeling system 650 are executed by processing device 602. For example, when at least some portion of the expertise modeling system 650 is embodied in instructions to cause processing device 602 to perform the method(s) described herein, some of those instructions can be read into processing device 602 (e.g., into an internal cache or other memory) from main memory 604 and/or data storage system 640. However, it is not required that all of the expertise modeling system 650 be included in instructions 612 at the same time and portions of the expertise modeling system 650 are stored in at least one other component of computer system 600 at other times, e.g., when at least one portion of the expertise modeling system 650 are not being executed by processing device 602.

The computer system 600 further includes a network interface device 608 to communicate over the network 620. Network interface device 608 provides a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation network interface device 608 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 includes an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, haptic information, and/or digital imagery, for example.

The data storage system 640 includes a machine-readable storage medium 642 (also known as a computer-readable medium) on which is stored at least one set of instructions 644 or software embodying any of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media. In one embodiment, the instructions 644 include instructions to implement functionality corresponding to an expertise modeling system 650 (e.g., portions of the computing system 100, 200, or 300, or the expertise modeling system 480 of FIG. 4).

Dashed lines are used in FIG. 6 to indicate that it is not required that the expertise modeling system be embodied entirely in instructions 612, 614, and 644 at the same time. In one example, portions of the expertise modeling system are embodied in instructions 614, which are read into main memory 604 as instructions 614, and portions of instructions 612 are read into processing device 602 as instructions 612 for execution. In another example, some portions of the expertise modeling system are embodied in instructions 644 while other portions are embodied in instructions 614 and still other portions are embodied in instructions 612.

While the machine-readable storage medium 642 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine that cause the machine to perform any of the methodologies of the present disclosure. The term “machine-readable storage medium” shall accordingly be taken to include, but not be limited to, solid-state memories, optical media, and magnetic media. The examples shown in FIG. 6 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, 200, 300, 400, or 600, can carry out the above-described computer-implemented methods in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Illustrative examples of the technologies disclosed herein are provided below. An embodiment of the technologies may include any of the examples described herein, or any combination of any of the examples described herein, or any combination of any portions of the examples described herein.

In an example 1, a method includes obtaining, from at least one electronic data source, evidence including unstructured data associated with an entity; extracting, from the evidence, a set of entity features including at least one digital description of expertise associated with the entity; encoding the set of entity features, including the at least one digital description of expertise, in digital form, into an entity feature embedding; extracting, from the entity feature embedding, at least one entity expertise embedding that encodes an entity domain and a level of expertise of the entity in the entity domain; and storing the at least one entity expertise embedding in digital form as an entity embedding.

An example 2 includes the subject matter of example 1, further including outputting at least one of the at least one entity expertise embedding or the entity embedding to at least one (i) model, (ii) process, (iii) component, (iv) network, (v) system or (vi) combination of any of (i), (ii), (iii), (iv), or (v). An example 3 includes the subject matter of example 1, where the encoding the set of entity features and the extracting the at least one entity expertise embedding are performed by an expertise model, the expertise model is trained on a plurality of training examples, and a training example of the plurality of training examples includes evidence of expertise in a domain, a label including the domain, and predictive data including a likelihood that the evidence indicates a level of expertise in the domain. An example 4 includes the subject matter of example 3, where the expertise model includes a neural network model, the neural network model includes an encoder network and an attention network coupled to output of the encoder network, the encoding the set of entity features is performed by the encoder network, and the extracting the at least one entity expertise embedding is performed by the attention network. An example 5 includes the subject matter of example 4, where the neural network model further includes a fusion network coupled to output of the attention network, and the method further includes, by the fusion network, combining at least two entity expertise embeddings extracted from the entity feature embedding into the entity embedding. An example 6 includes the subject matter of example 1, where the at least one entity expertise embedding includes a probability that the entity includes the level of expertise in the entity domain. An example 7 includes the subject matter of example 1, further including: encoding a query, in digital form, into a feature embedding; extracting, from the feature embedding, at least one query expertise embedding that encodes a query domain, a level of expertise in the query domain, and a probability that the query includes the level of expertise in the query domain; storing the at least one query expertise embedding in digital form as a query embedding; and generating digital output based on a comparison of the query embedding to the entity embedding. An example 8 includes the subject matter of example 7, where (i) the encoding the set of entity features, the extracting the at least one entity expertise embedding, and combining at least one entity expertise embedding extracted from the entity feature embedding are performed by a first tower of a neural network model, (ii) the encoding the query and the extracting the at least one query expertise embedding are performed by a second tower of the neural network model, and (iii) the first and second towers of the neural network model are trained on a plurality of training examples, where a training example of the plurality of training examples includes evidence of expertise in a domain, a label including the domain, and predictive data including a likelihood that the evidence indicates a level of expertise in the domain. An example 9 includes the subject matter of example 8, where the neural network model further includes at least one task-specific component coupled to the first tower and the second tower, and the at least one task-specific component is fine-tuned to generate task-specific output based on at least the entity embedding including the at least one entity expertise embedding and the query embedding including the at least one query expertise embedding. An example 10 includes the subject matter of example 9, where the task-specific output includes at least one of: an indication that an entity expertise matches a query expertise, a ranking of entities based on a level of expertise, or a ranking of domains of expertise for an entity based on a level of expertise. An example 11 includes the subject matter of example 7, where the query includes at least one of: a search for at least one entity that has a level of expertise that matches a level of expertise associated with the query, a request for a ranking of entities based on a level of expertise, a request for a ranking of domains of expertise for an entity based on a level of expertise, a document including a description of expertise, or a job description. An example 12 includes the subject matter of example 1, where the entity includes (i) a user of an online system, (ii) a prospective contributor to an online article, (iii) a prospective candidate for an online job opening, (iv) an organization, company, or institution, or (v) an article, document, video, audio file, or image. An example 13 includes the subject matter of example 1, where at least one digital description of expertise associated with the entity includes at least one of: (i) at least a portion of an online user profile of the entity including at least one skill description, experience, education, job title, company name, certification, achievement, or award, (ii) an electronic submission by the entity related to an online job posting, (iii) an article, post, share, reaction, edit, or comment published by the entity via an online system, (iv) an article, post, share, reaction, edit, or comment published via an online system by a different entity about the entity, (v) online activity of the entity, or (vi) online activity of the different entity that relates to the entity.

In an example 14, a system includes: at least one processor; and at least one memory coupled to the at least one processor, where the at least one memory includes at least one instruction that, when executed by the at least one processor, is capable of causing the at least one processor to perform at least one operation including: obtaining, from at least one electronic data source, evidence including unstructured data associated with an entity; extracting, from the evidence, a set of entity features including at least one digital description of expertise associated with the entity; encoding the set of entity features, including the at least one digital description of expertise, in digital form, into an entity feature embedding; extracting, from the entity feature embedding, at least one entity expertise embedding that encodes an entity domain and a level of expertise of the entity in the entity domain; and storing the at least one entity expertise embedding in digital form as an entity embedding. An example 15 includes the subject matter of example 14, where the at least one instruction, when executed by the at least one processor, is capable of causing the at least one processor to perform at least one operation further including: outputting at least one of the at least one entity expertise embedding or the entity embedding to at least one (i) model, (ii) process, (iii) component, (iv) network, (v) system or (vi) combination of any of (i), (ii), (iii), (iv), or (v). An example 16 includes the subject matter of example 14, where the encoding the set of entity features and the extracting the at least one entity expertise embedding are performed by an expertise model, the expertise model is trained on a plurality of training examples, and a training example of the plurality of training examples includes evidence of expertise in a domain, a label including the domain, and predictive data including a likelihood that the evidence indicates a level of expertise in the domain. An example 17 includes the subject matter of example 16, where the expertise model includes a neural network model, the neural network model includes an encoder network and an attention network coupled to output of the encoder network, the encoding the set of entity features is performed by the encoder network, and the extracting the at least one entity expertise embedding is performed by the attention network.

In an example 18, at least one non-transitory machine readable medium includes at least one instruction that, when executed by at least one processor, is capable of causing the at least one processor to perform at least one operation including: obtaining, from at least one electronic data source, evidence including unstructured data associated with an entity; extracting, from the evidence, a set of entity features including at least one digital description of expertise associated with the entity; encoding the set of entity features, including the at least one digital description of expertise, in digital form, into an entity feature embedding; extracting, from the entity feature embedding, at least one entity expertise embedding that encodes an entity domain and a level of expertise of the entity in the entity domain; and storing the at least one entity expertise embedding in digital form as an entity embedding. An example 19 includes the subject matter of example 18, where the entity includes (i) a user of an online system, (ii) a prospective contributor to an online article, (iii) a prospective candidate for an online job opening, (iv) an organization, company, or institution, or (v) an article, document, video, audio file, or image. An example 20 includes the subject matter of example 18, where at least one digital description of expertise associated with the entity includes at least one of: (i) at least a portion of an online user profile of the entity including at least one skill description, experience, education, job title, company name, certification, achievement, or award, (ii) an electronic submission by the entity related to an online job posting, (iii) an article, post, share, reaction, edit, or comment published by the entity via an online system, (iv) an article, post, share, reaction, edit, or comment published via an online system by a different entity about the entity, (v) online activity of the entity, or (vi) online activity of the different entity that relates to the entity.

An example 21 includes any of the other examples, where at least one expertise embedding is used to generate query suggestions based on the at least one expertise embedding or to enhance or modify one or more queries based on the at least one expertise embedding. An example 22 includes any of the other examples, where the entity for which the at least one expertise embedding is generated is a computing resource, such that at least one expertise embedding is generated for each computing resource in a set of candidate computing resources, where the expertise embedding represents a suitability of each of the candidate computing resources for a particular computing task, and the expertise embeddings are used to allocate one or more candidate computing resources to computing tasks based on the expertise embeddings.

An example 23 includes the method of any of the preceding examples, further including any one or more aspects, steps, components, elements, processes, or limitations that are at least one of described in the enclosed description or shown in the accompanying drawings. An example 24 includes a system, including: at least one processor; and at least one memory coupled to the at least one processor, where the at least one memory includes instructions that, when executed by the at least one processor, cause the at least one processor to perform at least one operation including the method of any of examples 1-13 or 21-23. An example 25 includes at least one non-transitory machine-readable storage medium, including instructions that, when executed by at least one processor, cause the at least one processor to perform at least one operation including the method of any of examples 1-13 or 21-23.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
obtaining, from at least one electronic data source, evidence comprising unstructured data associated with an entity;
extracting, from the evidence, a set of entity features comprising at least one digital description of expertise associated with the entity;
encoding the set of entity features, including the at least one digital description of expertise, in digital form, into an entity feature embedding;
extracting, from the entity feature embedding, at least one entity expertise embedding that encodes an entity domain and a level of expertise of the entity in the entity domain; and
storing the at least one entity expertise embedding in digital form as an entity embedding.

2. The method of claim 1, further comprising:
outputting at least one of the at least one entity expertise embedding or the entity embedding to at least one (i) model, (ii) process, (iii) component, (iv) network, (v) system or (vi) combination of any of (i), (ii), (iii), (iv), or (v).

3. The method of claim 1, wherein the encoding the set of entity features and the extracting the at least one entity expertise embedding are performed by an expertise model, the expertise model is trained on a plurality of training examples, and a training example of the plurality of training examples comprises evidence of expertise in a domain, a label comprising the domain, and predictive data comprising a likelihood that the evidence indicates a level of expertise in the domain.

4. The method of claim 3, wherein the expertise model comprises a neural network model, the neural network model comprises an encoder network and an attention network coupled to output of the encoder network, the encoding the set of entity features is performed by the encoder network, and the extracting the at least one entity expertise embedding is performed by the attention network.

5. The method of claim 4, wherein the neural network model further comprises a fusion network coupled to output of the attention network, and the method further comprises, by the fusion network, combining at least two entity expertise embeddings extracted from the entity feature embedding into the entity embedding.

6. The method of claim 1, wherein the at least one entity expertise embedding comprises a probability that the entity comprises the level of expertise in the entity domain.

7. The method of claim 1, further comprising:
encoding a query, in digital form, into a feature embedding;
extracting, from the feature embedding, at least one query expertise embedding that encodes a query domain, a level of expertise in the query domain, and a probability that the query comprises the level of expertise in the query domain;
storing the at least one query expertise embedding in digital form as a query embedding; and
generating digital output based on a comparison of the query embedding to the entity embedding.

8. The method of claim 7, wherein (i) the encoding the set of entity features, the extracting the at least one entity expertise embedding, and combining at least one entity expertise embedding extracted from the entity feature embedding are performed by a first tower of a neural network model, (ii) the encoding the query and the extracting the at least one query expertise embedding are performed by a second tower of the neural network model, and (iii) the first and second towers of the neural network model are trained on a plurality of training examples, wherein a training example of the plurality of training examples comprises evidence of expertise in a domain, a label comprising the domain, and predictive data comprising a likelihood that the evidence indicates a level of expertise in the domain.

9. The method of claim 8, wherein the neural network model further comprises at least one task-specific component coupled to the first tower and the second tower, and the at least one task-specific component is fine-tuned to generate task-specific output based on at least the entity embedding including the at least one entity expertise embedding and the query embedding including the at least one query expertise embedding.

10. The method of claim 9, wherein the task-specific output comprises at least one of: an indication that an entity expertise matches a query expertise, a ranking of entities based on a level of expertise, or a ranking of domains of expertise for an entity based on a level of expertise.

11. The method of claim 7, wherein the query comprises at least one of: a search for at least one entity that has a level of expertise that matches a level of expertise associated with the query, a request for a ranking of entities based on a level of expertise, a request for a ranking of domains of expertise for an entity based on a level of expertise, a document comprising a description of expertise, or a job description.

12. The method of claim 1, wherein the entity comprises (i) a user of an online system, (ii) a prospective contributor to an online article, (iii) a prospective candidate for an online job opening, (iv) an organization, company, or institution, or (v) an article, document, video, audio file, or image.

13. The method of claim 1, wherein at least one digital description of expertise associated with the entity comprises at least one of: (i) at least a portion of an online user profile of the entity including at least one skill description, experience, education, job title, company name, certification, achievement, or award, (ii) an electronic submission by the entity related to an online job posting, (iii) an article, post, share, reaction, edit, or comment published by the entity via an online system, (iv) an article, post, share, reaction, edit, or comment published via an online system by a different entity about the entity, (v) online activity of the entity, or (vi) online activity of the different entity that relates to the entity.

14. A system comprising:
at least one processor; and
at least one memory coupled to the at least one processor, wherein the at least one memory comprises at least one instruction that, when executed by the at least one processor, is capable of causing the at least one processor to perform at least one operation comprising:
obtaining, from at least one electronic data source, evidence comprising unstructured data associated with an entity;
extracting, from the evidence, a set of entity features comprising at least one digital description of expertise associated with the entity;
encoding the set of entity features, including the at least one digital description of expertise, in digital form, into an entity feature embedding;
extracting, from the entity feature embedding, at least one entity expertise embedding that encodes an entity domain and a level of expertise of the entity in the entity domain; and
storing the at least one entity expertise embedding in digital form as an entity embedding.

15. The system of claim 14, wherein the at least one instruction, when executed by the at least one processor, is capable of causing the at least one processor to perform at least one operation further comprising:
outputting at least one of the at least one entity expertise embedding or the entity embedding to at least one (i) model, (ii) process, (iii) component, (iv) network, (v) system or (vi) combination of any of (i), (ii), (iii), (iv), or (v).

16. The system of claim 14, wherein the encoding the set of entity features and the extracting the at least one entity expertise embedding are performed by an expertise model, the expertise model is trained on a plurality of training examples, and a training example of the plurality of training examples comprises evidence of expertise in a domain, a label comprising the domain, and predictive data comprising a likelihood that the evidence indicates a level of expertise in the domain.

17. The system of claim 16, wherein the expertise model comprises a neural network model, the neural network model comprises an encoder network and an attention network coupled to output of the encoder network, the encoding the set of entity features is performed by the encoder network, and the extracting the at least one entity expertise embedding is performed by the attention network.

18. At least one non-transitory machine readable medium comprising at least one instruction that, when executed by at least one processor, is capable of causing the at least one processor to perform at least one operation comprising:
obtaining, from at least one electronic data source, evidence comprising unstructured data associated with an entity;
extracting, from the evidence, a set of entity features comprising at least one digital description of expertise associated with the entity;
encoding the set of entity features, including the at least one digital description of expertise, in digital form, into an entity feature embedding;
extracting, from the entity feature embedding, at least one entity expertise embedding that encodes an entity domain and a level of expertise of the entity in the entity domain; and
storing the at least one entity expertise embedding in digital form as an entity embedding.

19. The at least one non-transitory machine readable medium of claim 18, wherein the entity comprises (i) a user of an online system, (ii) a prospective contributor to an online article, (iii) a prospective candidate for an online job opening, (iv) an organization, company, or institution, or (v) an article, document, video, audio file, or image.

20. The at least one non-transitory machine readable medium of claim 18, wherein at least one digital description of expertise associated with the entity comprises at least one of: (i) at least a portion of an online user profile of the entity including at least one skill description, experience, education, job title, company name, certification, achievement, or award, (ii) an electronic submission by the entity related to an online job posting, (iii) an article, post, share, reaction, edit, or comment published by the entity via an online system, (iv) an article, post, share, reaction, edit, or comment published via an online system by a different entity about the entity, (v) online activity of the entity, or (vi) online activity of the different entity that relates to the entity.
